(19) United States
(12) Patent Application Publication
(10) Pub. No.: US 2016/0239733 A1
(43) Pub. Date: Aug. 18, 2016

(54) MISPLACED OR FORGOTTEN ARTICLE RECOVERY PROCESS

(71) Applicants: Allen D. HERTZ, Boca Raton, FL (US); Paul K. Silverberg, Weston, FL (US)

(72) Inventors: Allen D. HERTZ, Boca Raton, FL (US); Paul K. Silverberg, Weston, FL (US)

(21) Appl. No.: 15/138,195

(22) Filed: Apr. 25, 2016

Related U.S. Application Data
(63) Continuation-in-part of application No. 14/550,932, filed on Nov. 22, 2014.
Application No. 14/550,932 is a continuation-in-part of application No. 13/901,544, filed on May 23, 2013.
(60) Provisional application No. 61/650,984, filed on May 23, 2012.
(60) Provisional application No. 61/908,057, filed on Nov. 23, 2013.
(60) Provisional application No. 62/152,959, filed on Apr. 26, 2015.

(51) Int. Cl. G06K 19/06; G06F 17/30

(52) U.S. Cl. CPC G06K 19/06028; G06K 19/06037; G06F 17/30887; G06F 17/30368; G06F 17/30241

(57) ABSTRACT

A misplaced article recovery system utilizing an application operating on a computing device, such as a point of sale system, a Smartphone, a tablet, and the like. A unique article registration identifier (numeric or alphanumeric) is associated with a registrant. A tag, label, or other identifying element is attached or permanently applied onto (etched, printed, etc.) each desired article. An application operating on an application hosting device obtains the unique article registration number and a current location of the misplaced article. The article registration identifier and reported article location are forwarded to an article return service provider. The article return service provider determines the registrant and associated contact information, then informs the owner that the article has been reported at the current article location. The owner returns to the reported location and retrieves the misplaced article. The system maintains privacy and anonymity between parties.

### CROSS-REFERENCE TO RELATED APPLICATIONS

This Non-Provisional patent application is:
(a) a Continuation-In-Part claiming the benefit of U.S. Non-Provisional patent application Ser. No. 14/550,932, filed on Nov. 22, 2014, which is
   (1) a Continuation-In-Part claiming the benefit of: U.S. Non-Provisional patent application Ser. No. 13/901,544, filed on May 23, 2013, which claims the benefit of co-pending U.S. Provisional Patent Application Ser. 61/650,984, filed on May 23, 2012, and
   (2) a Non-Provisional patent application claiming the benefit of U.S. Provisional Patent Application Ser. 61/908,057, filed on Nov. 23, 2013, and
(b) a Non-Provisional patent application claiming the benefit of U.S. Provisional Patent Application Ser. 62/152,959, filed on Apr. 26, 2015,

all of which are incorporated by reference into this Non-Provisional patent application in their entireties.

### FIELD OF THE INVENTION

This invention relates to a process for returning a misplaced, lost, or forgotten article to an associated person. More particularly, the present invention relates to computer-implemented methods for identifying a location and contact information of a registered person of a misplaced or lost article, financial card, child, adult, or any other registered objects and validation of proper associated person employing an application and/or a website accessed and utilized by a crowd or social network, while maintaining privacy and anonymity between parties.

### BACKGROUND OF THE INVENTION

People have a tendency to accidentally loose or leave articles behind. People have a tendency to forget credit cards, debit cards, keys, umbrellas, luggage, backpacks, purses, wallets, camera bags, shopping bags, eyewear, computers, tablets, cellular phones, and the like. Any of a variety of factors could distract an individual, where they would leave the article behind. Additionally, articles can drop or fall out of pockets while a person or child is walking, running, strolling, or traveling in any other manner.

Other people find the lost, misplaced, forgotten, or dropped articles, but have no way to locate the rightful owner. The rightful owner would recognize that they had left behind certain articles quickly, simply by the nature of the specific article, such as car keys, certain eyeglasses, and the like. Other articles are less likely to be recognized as being forgotten or missing until much later. These can include credit or debit cards, umbrellas, backpacks, shopping bags, wallets, reading glasses, and the like. The number of locations which the owner has visited during the time span increases the complexity and time to retrace their path of travel to locate the missing article. This is aggravated if the owner is in a rush, such as a lunch break, on their way to a meeting, heading home, traveling to a scheduled event, and the like. The increase in time between the actual loss of the article and the time where the owner realizes that the article is lost reduces the likelihood of recovering the article.

The loss of credit cards complicates the situation for the card owner. The card owner might have established payment arrangements through the credit card. Credit card issuing companies change the owner's account number when replacing a lost or stolen card. Therefore, the card owner would have to contact each of the companies that have an automatic payment transaction associated with the card. This is further aggravated when the card owner is traveling, such as on a cruise, across country, overseas, or any other location where they are unable to obtain a replacement card in a timely manner. The inconvenience can significantly impact the trip. For example, when a family is on a cruise and they accidentally leave a credit card at a restaurant on an island. They return to the cruise ship, which sails from the port shortly thereafter. The cardholder realizes the card was left behind when the cardholder attempts to make a purchase either on the cruise ship or at the next port of call. The card is commonly associated with all purchases on the cruise ship. Now the cardholder needs to resolve the association for purchases on the cruise ship and how to accommodate future purchases without the ability to use the lost card.

Occasionally, a customer will leave a credit card at a merchant, restaurant, or other place of business. The place of business must maintain the credit card in a secured location until the owner returns to retrieve the forgotten card. It is rare that the place of business has a means for contacting the owner of the card. Therefore, the return of the card relies upon the owner's memory or detective work to determine where the owner left the card.

The owner may opt to contact the credit card company to cancel the lost card and issue a replacement card. The credit card company then closes the account under the card number respective to the misplaced card and establishes a new account. The balance is transferred from the old account to the new account. The replacement card is forwarded to the card account owner via an overnight parcel service. The overall replacement process is completed at a cost to the card issuer. The same applies to a debit card.

Therefore, a process for locating and returning a lost or forgotten article, including credit cards, debit cards, keys, umbrellas, luggage, backpacks, purses, wallets, camera bags, shopping bags, eyewear, computers, tablets, cellular phones, to a rightful owner is desired.

### SUMMARY OF THE INVENTION

The present disclosure is generally directed to an apparatus and respective method for notifying a rightful owner or registrant that an article left at a merchant (or other location) has been found and a current location thereof
establishing a plurality of registrant's accounts on an article return service provider server, wherein each registrant's account of the plurality of registrant's accounts is associated with a rightful owner;
storing a series of unique article identifiers on the article return service provider server;
establishing an association between each unique article identifier of the series of unique article identifiers and an associated registrant's account of the plurality of registrant's accounts by way of an article ownership index stored on the article return service provider server;
applying one of the unique article identifiers of the series of unique article identifiers onto an article;
locating the article when the article is forgotten at a location;
activating an article location notification application on an application hosting device, wherein the application hosting device is one of: a networked computer, a point of sale computing device, a portable computing device, a tablet, a Smartphone, and a portable computing watch; entering the unique article identifier into the application hosting device;
determining a current location of the forgotten article;
transmitting the unique article identifier and the current location of the forgotten article to the article return service provider server;
utilizing the article ownership index stored on the article return service provider server to determine the rightful owner of the forgotten article and an associated contact method based upon the registrant's account; and
transmitting a notification message to the rightful owner by way of the associated contact method, wherein the notification message conveys that a forgotten article has been located and a reported current location of the forgotten article.

In second aspect, the location of the forgotten article is determined by a global positioning system (GPS) integrated into the application hosting device.

In another aspect, the location of the forgotten article is determined by a data entry manually entered or previously established by an article locating individual.

In yet another aspect, the process can employ a tag, label, and the like for associating a unique article registration identifier with an article. The article registration identifier can be associated with an owner, where the owner would have multiple tags having the same article registration identifier for attachment to different articles.

In another aspect, the article registration identifier can be presented as a numeric representation, an alphanumeric representation, a barcode, a QR code, or any other human and/or machine readable format.

In yet another aspect, the appliqué can additionally include application access information to inform a person who finds the misplaced or forgotten article how to acquire the application for returning the article to the rightful owner.

In yet another aspect, the unique article identifiers can be applied to the article by at least one of:
(a) marking the unique article identifier into the article,
(b) etching the unique article identifier into the article,
(c) engraving the unique article identifier into the article,
(d) printing the unique article identifier into the article,
(e) stamping the unique article identifier into the article,
(f) attaching the unique article identifier via a receipt or other paper to the article, and
(g) fabricating the article with the unique article identifier in it.

In yet another aspect, the process can introduce incentives to submit information to the article return service provider using the associated application. The incentives can be rewards from the merchant at the location the article was found, from a merchant associated with the article, from another merchant, from the rightful owner of the article, and the like.

In yet another aspect, the reward can be in a form of a donation to a non-profit organization determined by the reward recipient rightful owner, or another registered third party.

In yet another aspect, the reward can be selected from a suggested listing of reward values. The article rightful owner would select the reward from the suggested list. The reward can be processed using any suitable financial reward process, including a bank transfer, a credit card payment, a gift card value, and the like.

In yet another aspect, the reward can be in a form of a gratuity, such as sending flowers, sending an edible bouquet, sending a card, sending an e-card, offering a service, and the like.

In yet another aspect, the process can be adapted for notifying an individual when their luggage is placed upon a luggage carousel. An RFID transceiver or other passive-transmissive tag can be attached to the individual's luggage. The unique identifier of the tag would be associated with the individual. The association is recorded in an index on a database. The tag would be identified by a tag reader located proximate the luggage carousel. The information would be forwarded to a server. The server would identify the contact information of the individual associated with the tag and subsequently notify the individual of the status of the luggage. The notification can be direct to the individual, such as a message received by a Smartphone, a posting on a display, and the like.

In yet another aspect, the posting on a display can be encrypted, using the individual's initials, a user name, a flight and seat number, unique generated code, and the like to avoid displaying the individual's name.

In a more specific embodiment directed towards returning a financial card, the apparatus and respective method for pairing the financial card with a respective card owner includes steps of:
providing access to a financial card recovery database via a network;
entering information respective to a financial card, the information including a credit card number and a credit card owner's name;
entering a current location of the financial card;
entering an owner's information for locating a misplaced financial card, the owner's information including: the credit card owner's name and a billing address;
identifying misplaced cards having owner's information that match the owner's information entered by the searching party; and
determining the matching card by submitting the misplaced card number and the credit card owner's billing address and comparing the submitted credit card owner's billing address with a registered billing address of the misplaced card number.

In a variant of the generic embodiment, the apparatus and respective method for returning a misplaced financial card to a rightful card owner, the method comprising steps of:
activating an application residing on a portable computing device, said computing device comprising a digital camera;
acquiring card information from said misplaced financial card, wherein the step is accomplished by obtaining a digital image of said misplaced card using said digital camera;
acquiring a location of said misplaced card into a digital format, wherein said misplaced card location is digitally recorded by said portable computing device;
determining which card issuing company issued said misplaced card by comparing at least a portion of said card number with a listing of card issuing companies, wherein said listing of card issuing companies comprises each issuing card company, an associated card number coding of each respective card issuing company and contact information for communicating with said respective card issuing company is stored within said listing of issuing card companies;
providing said acquired card information and said misplaced card location to said card issuing company associated with said misplaced card using a communication process associated with said card issuing company contact information;
determining a rightful card owner by comparing at least a portion of said acquired card information from an index of issued cards, wherein each issued card is associated with a respective card owner and associated card owner contact information in said index of issued cards, wherein said index of issued cards is recorded in a database stored on a card issuing company database storage device; and
informing said rightful card owner that said misplaced card is located and including said location of said misplaced card.

In another aspect, the searching party additionally enters a geographic location where the owner believes the card was misplaced. In one exemplary embodiment, the owner can enter a city and state. In a second exemplary embodiment, the owner can enter a zip code. In a third exemplary embodiment, the owner can enter a longitude and latitude or similar geographic coordinate.

In yet another aspect, the misplaced cards are searched by sorting the list of identified misplaced cards by geographic location in order of distance from the owner's provided suspect location.

In yet another aspect the system determines the card match by processing a charge against the information submitted. Should the charge be authorized, the process determines the information is a match. Should the charge be declined, the process continues with the next suspect card.

In yet another aspect, the process includes a fee for the service of identifying the card location. The service fee is provided by the authorization process.

In yet another aspect, the process is accomplished via the Internet.

In yet another aspect, the merchant can create and save a profile, including login information, address, contact information, and the like.

In yet another aspect, a profile can include a single log in account, the account having a plurality of locations which the merchant selects the respective location having the financial card.

In yet another aspect, the characters on the card are identified using optical character recognition.

In yet another aspect, the process can obtain information associated with the credit card by electronically reading a computer readable storage element.

In yet another aspect, the process can identify an issuing card company from one of a portion of the financial or credit card number and an issuing company identifying image displayed upon a surface of the financial or credit card.

In yet another aspect, the process can identify an issuing card company from a portion of the financial or credit card number and interrogating an issuing card company index database stored on a server.

In yet another aspect, the process includes a step of providing card information and a current location of the associated card to the issuing card company.

In yet another aspect, the process includes a step of identifying a rightful owner by interrogating a card account database stored on a card account server, wherein the card account server is under a governess of the issuing card company.

In yet another aspect, the process can be applied to articles, wherein each article would include an identifier unique to the article return service provider database.

In yet another aspect, the process includes a step of identifying at least one communication process for informing the rightful owner of a location of the missing card, article, and the like.

In yet another aspect, the process includes a step of informing the rightful owner of a location of the missing card, article, and the like, wherein the step includes at least one of the following communication processes: email, SMS or text message, audio alert or message, instant messaging, social media correspondence, printed correspondence, and the like.

In yet another aspect, the step of informing the rightful owner of the current location of the missing card, article, and the like, is provided in a human readable alpha-numeric format.

In yet another aspect, the step of informing the rightful owner of the current location of the missing card, article, and the like, is provided in a form of a map. The map can be interactive, identifying both the rightful owner's current location and the location where the article was scanned. The map can be enhanced by providing directions from the rightful owner's current location to the location where the article was scanned.

In yet another aspect, the process can employ a label comprising an identifier. The identifier would be unique to the network. The identifier would preferably be presented in both machine readable and human readable formats. It is understood that the identifier can be human readable and the portable computing device would employ Optical Character Recognition (OCR) to acquire information associated with the identifier in a machine friendly format. The human readable format enables manual entry of the identifier.

In yet another aspect, the labels can be applied to any suitable object. Examples of suitable objects include: luggage, handbags, camera bags, backpacks, carrying containers, storage containers, receipts, shopping bags, wallets, key chains, keys, financial cards, driver's licenses, umbrellas, walking assistance devices, walking canes, cameras, eyewear, portable computing devices, cellular telephones, tablets, laptops, portable computing device carrying cases, headphones, portable speakers, binoculars, pet tags, pet collars, pet bands, jewelry, watches, firearms, tools, rental equipment, clothing, shoes, hats, books, children's toys, blankets, dental appliances, dentures, shopping carts, strollers, and personal disability mobility scooters, and the like.

In yet another aspect, the identifier can be etched into or printed upon an object, such as a keychain, jewelry, portable computing devices (including cellular phones, tablets, laptops, etc.), pet tags, luggage tags, eyewear, dental appliances (such as dentures, etc.), handbag badges, and the like.

In yet another aspect, the identifier can be a unique identifier previously assigned to the article, such as a vehicle identification number (VIN), license plate (including the state identification), and the like. This provides several benefits, such as enabling others to notify the vehicle owner that the lights were left on; it would enable law enforcement to notify an owner of a vehicle of an issue; and the like.

In yet another aspect, the system can be integrated with a Point of Sale (POS) system. The user would provide a device (such as a card, a phone number, an RFID band, and the like) that would provide (directly or indirectly) the Point of Sale (POS) system with an association to the user's account. The Point of Sale (POS) system would complete the sales transaction and print a receipt. The receipt would include an identifier that is registered with the user's account. The registration of the identifier can be accomplished in any suitable series of steps. For example, the system can generate and forward the identifier to the Point of Sale (POS) system. The Point of Sale (POS) system would then print the identifier onto the receipt.

In yet another aspect, the identifiers can be permanently applied to an object, such as a watch or other jewelry, eyewear, bicycles, helmets, cellular telephones, portable computing devices, tools, rental equipment, and the like to deter theft, track inventory, or provide any other like benefits. The potential buyer can enter the identifier into the system. The system would utilize the identifier to determine if the identifier is registered, then if the identifier is registered, the system would then notify the currently registered owner.

In yet another aspect, the system provides a communication process between a person in possession of an article and a rightful or registered owner. The system enables communication using anonymity. The system acts as an intermediary between the person in possession of an article and the rightful or registered owner.

In yet another aspect, the system can employ RFID or near field communications (NFC) for limited applications, such as luggage, and the like. It is understood that the utilization of near field communications (NFC) enables a potential of unwanted monitoring of a location of an individual. Non-wireless configurations, such as visually accessible configurations (labels, markings, etching, etc.) deter this potential concern.

In yet another aspect, the process can be adapted to track movement of an object. Each time the identifier is scanned or entered into the system, the system would record the identifier, the location where the identifier was scanned or entered, and the time and date in which the scan occurred.

In yet another aspect, the system can retain a history of the notifications of found articles, changes to each user's accounts, and the like.

In yet another aspect, the system can provide anonymous communications between two parties by acting as a switchboard.

In yet another aspect, a new user can be automatically registered to the system when the new user is generating an engraved identification tag, such as a pet tag, a Dog Tag, a luggage tag, and the like.

In yet another aspect, the process can employ bracelets, wherein the bracelets are adorned with a unique identifier.

In yet another aspect, the bracelet can be associated with a child and associated with a parent, grandparent, sibling, other family member, or other caretaker, wherein the system would notify the associated party of the child's whereabouts when the child is separated from the associated party.

In yet another aspect, the system can be adapted to pair two identifiers, wherein upon reading a first identifier, the system would be seeking to read a second paired identifier. For example, the first identifier is associated with a child. The second identifier is associated with guardian of the child. This pairing ensures that the child remains in a proximity of the respective guardian. Alternatively, if the child and guardian become separated from one another, the first identifier would be scanned or entered, which automatically triggers a message to the respective guardian.

In yet another aspect, the bracelet can be associated with a medical condition and forward a message to a caretaker if the individual is found to be lost. This could be applied to patients with dementia, Alzheimer's, seizures, disabilities, and the like.

In yet another aspect, the bracelet can be associated with medical information, wherein when the bracelet is scanned, the medical information is forwarded or made available to a medical provider, such as an emergency medical technician (EMT), a hospital, and the like. The system can establish a process for identifying when the request is from the medical provider and forward the associated medical information to the medical provider that scanned the identifier on the bracelet. One example would be where the associated message transmitted to the host server includes contact information of at least one of the scanning device, medical provider, and the like.

In yet another aspect, the user can optionally upload an image of one or more registered articles. The system would retain the uploaded image. The image of the article would be forwarded to the owner when the article is found.

In yet another aspect, the finding party can optionally upload an image of the found article. The system would identify the registered owner and forward the image to the owner in conjunction with the location of the article.

In yet another aspect, the article identifiers would be known by the system prior to distribution to ensure against registration of fraudulent article identifiers.

In yet another aspect, the registered information can be edited, added, and/or deleted. The registered information can include the contact information, information used to identify the article, and the like.

In yet another aspect, the article identifier can be integrated into a screen saver or any other viewable screen image, wherein the screen saver would activate while the computing device is locked. The article identifier can be used to inform the owner of the location of the computing device. In an alternative or enhanced embodiment, the identifier could be associated with a user's password, wherein the user could scan the device and the system would transmit the password to the user on a separate device. In an alternative to a screen saver, the viewable screen image can be accessed by a motion across the screen, a keyboard stroke, a button actuation, and the like. The article identifier can be embedded into an image where the article identifier is not human legible, but would be recognized by a computer imaging process.

In yet another aspect, the system can be adapted to provide an object location recording process. The owner would scan the identifier of each object. The system would determine the location of the object when the identifier is scanned. The object and location would be logged and stored for future reference. The information can be accessed through any suitable method, such as a website through the Internet.

In yet another aspect, the system can incorporate a feedback option, wherein the registering party can provide feedback. The feedback can be in a form of general or freeform feedback, a survey, and the like. The feedback can be directed towards the article return service, the article associated with the unique article identifier, the merchant selling the article associated with the unique article identifier, a party that located a misplaced article, a rewards program, a merchant retailing tags associated with the article return service, and the like.

In yet another aspect, the concept can be applied to a scavenger hunt process, wherein the players would hunt for items listed by the game instructions. Each item would be identified by at least one of a machine readable article registration identifier and a human readable article registration identifier. The player would scan or manually enter the identifier into the portable computing device. The portable computing device would upload the identifier and the location to the host server. The host server would maintain the status of each player to eventually determine the winner.

In yet another aspect, the QR code can include an encoding identifying the QR code to a Universal Resource Locator (URL) (a website address). The QR code can further include an encoding comprising a unique identifier associated with the specific QR code. For example, the QR code can be encoded to include “http://FindLostThings.com html?id=OBJID0001”, where OBJID0001 is a unique identification associated with a specific object.

In another adapted method of use, the concept can be modified to employ a QR code reader, exclusive of a dedicated Application, the method comprising steps of:
reading a QR code comprising a Universal Resource Locator (URL), where the Universal Resource Locator (URL) includes a query string, the query string including a unique object identifier;
decoding the QR code comprising the Universal Resource Locator (URL);
accessing a website identified by the Universal Resource Locator (URL) obtained from the decoded QR code;
parsing the Universal Resource Locator (URL) to obtain the unique object identifier;
obtain the geocoordinates of a location of the electronic device using geolocation coding of the electronic device;
passing the parsed unique object identifier obtained from the decoded QR code and the obtained geocoordinates of the location of the electronic device to the web server associated with the Universal Resource Locator (URL);
determining contact information associated with a registrant of the QR code; and
providing the location of the electronic device (representative of the location of the article) to the registrant of the QR code.

In another aspect, the process further comprises a step of creating an association between the unique object identifier and the registrant of the QR code.

In another aspect, the step of obtain the geocoordinates of a location of the electronic device is accomplished using a portable computing device.

In another aspect, the step of obtain the geocoordinates of a location of the electronic device is accomplished using a portable computing device, the portable computing device is at least one of a portable computing laptop, a portable computing tablet, a Smartphone, a Personal Data Assistant (PDA), and the like.

In another aspect, the step of obtain the geocoordinates of a location of the electronic device is accomplished using a Global Positioning System (GPS) location identification system, a Wi-Fi based location identification system, a beacon based locating system, and the like, or any combination thereof.

In another aspect, the process converts the obtained geocoordinates of the location of the electronic device into an address associated with the obtained geocoordinates.

In another aspect, the process utilizes the obtained geocoordinates of the location of the electronic device to identify a location of the electronic device on a map.

In another aspect, the process utilizes the obtained geocoordinates of the location of the electronic device to identify a location of the electronic device on a static map.

In another aspect, the process utilizes the obtained geocoordinates of the location of the electronic device to identify a location of the electronic device on a live map, wherein the live map can provide a location to the registrant of the QR code and the location of the electronic device. The live map can additional offer and provide directions between the registrant and the obtained geocoordinates of the location of the electronic device.

In another aspect, the step of providing the location of the electronic device to the registrant of the QR code is accomplished by at least one of transmitting an email, transmitting a message using Short Message Service (SMS), transmitting a message using Multimedia Messaging Service (MMS), providing an audible telephone message, providing an automated telephone message, posting a message to an associated social media site, and the like.

In another adapted method of use, the concept is applied to a package reminder process, the process comprising steps of:
establishing a plurality of registrant's accounts on an article reminder service provider server, wherein each registrant's account of the plurality of registrant's accounts is associated with a registrant;
assigning a package identifier to a package, wherein each package identifier is uniquely identified for association with the associated registrant from all other registrants of the article reminder service provider;
recording each package identifier in a manner associating each package identifier with the appropriate registrant's account;
applying the package identifier to the package;
transferring the package to a package pick up location;
acquiring a personal identifier of registrants passing nearby a personal identifier monitoring station;
using the acquired personal identifier to determine all package identifiers associate with the acquired personal identifier;
determining if any packages having package identifiers associated with the acquired personal identifier currently reside at the package pick up location; and
in a condition where at least one package having the package identifier associated with the acquired personal identifier currently resides at the package pickup center, transmitting a message to the registrant associated with the acquired personal identifier, wherein the message reminds the registrant to pickup at least one package that is currently residing at the package pickup center.

In another aspect, the notification step is accomplished by sending at least one of: a text messaging, email, voice message, a personal phone call, or any other suitable communication service.

In another aspect, the package reminder service can be applied to any suitable application, including a cruise industry where the cruise ships monitor passenger embarking and disembarking, resorts and hotels where the resorts and hotels monitor check in and check-out of guests, airlines, and the like.

In another aspect, the package reminder service can be adapted to monitor for drop off and pick up of personal articles for children attending school, after school care, camp, daycare or any other similar facility.

In another aspect, the package identifier is determined by the package reminder service provider.

In another aspect, the package identifier is selected from a predetermined listing of package identifiers that are associated with the registrant.

In another aspect, the personal identifier is provided by a wireless device.

In another aspect, the personal identifier is provided by a passive wireless device.

In another aspect, the personal identifier is provided by an active and/or a passive wireless device integrated into a bracelet, a card, a band, a necklace or charm on a necklace, a pin, a tag, a label, and the like.

In another aspect, the personal identifier is provided by using a biometric identifier, wherein the biometric identifier can be at least one of a fingerprint, a palm print, an iris image, facial recognition, and the like.

In yet another aspect, the package identifier can be printed upon a sales receipt, a label, or any other medium adapted to receive printing. The package identifier can be printed in any format, including at least one of a machine readable format, a Quick Read (QR) code, a barcode, human legible text, and the like. The sales receipt, label or other printed upon item can be attached to the package, bag, article, and the like or inserted into the package, bag, and the like.

In another aspect, the package identifier can be communicated to the package pickup center prior to physical transfer of the package to ensure the package is received at the package pickup center.

In yet another aspect, the package identifier can be stored on the package return service provider server and/or associated data storage device, wherein the package identifier would be associated with the registrant's account.

In yet another aspect, the package identifier can be stored on a package pickup center server and/or associated data storage device, wherein the package identifier would be associated with the registrant's account.

In yet another aspect, process can additionally include a step of acquiring the personal identifier during the package pick up process to ensure proper ownership of the package prior to transfer or delivery of the package to the individual picking up the package.

In yet another aspect, the reminder method further comprising a step of determining a forwarding process for all packages remaining at the package pickup center after a predetermined time. Each remaining package can be transported to a central retrieval location, a hotel room associated with the respective registrant, a residence associated with the respective registrant, and the like.

In another embodiment, the same concept can be adapted for use in locating persons, such as children, elderly, disabled, mental or physically challenged, and the like.

In one aspect, the personal identifier would be provided on or within a wearable article, such as a bracelet; a badge; a charm on a necklace, a bracelet, an anklet; a pin, a button; and the like.

In another aspect, the personal identifier would be integrated into a wireless transmitter or transceiver.

In another aspect, the personal identifier would be integrated into a wireless transmitter or transceiver. In one embodiment, the wireless device would be a passive wireless transceiver, such as Radio Frequency Identification (RFID).

In yet another aspect, the system would utilize one or more deployed wireless receivers or transceivers to receive personal information from each associated personal identifier wearable article. The deployed receiving point would receive a signal from each associated personal identifier wearable article that is located within a predetermined short range or distance from the deployed receiving point. This enables the system to identify each individual associated with each personal identifier wearable article currently residing within a predetermined distance or radius from the deployed receiving point.

In yet another aspect, the system can identify the location of one or more individuals wearing the personal identifier wearable article that are currently located within a geographic region or structure, such as a school, a mall, an amusement park, a theme park, a carnival, an arena, a stadium, a park, a restaurant, a zoo, and the like.

In yet another aspect, the system can determine an identity of each individual and therefore, the number and identify of all individuals wearing the personal identifier wearable article that are located within the predetermined range. The information can be forward to one or more interested parties.

In yet another aspect, the system can employ a portable scanner or series of scanners to determine each personal identifier wearable article located within the predetermined range. It is understood that the portable scanners can be placed into a desired location, held by a person, or any other reasonable means of deployment.

In yet another aspect, the system can tally the number of people, compare names or identities with those listed in a central database, identify missing people, report location of people, report number of people per location, and the like.

In yet another aspect, the system can report acquired information to authorities (a school principal or other representative, police, fire/rescue, emergency medical services (EMS), and the like).

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, in which:

FIG. 1 presents an exemplary lost card location entry flow diagram;

FIG. 2 presents an exemplary searching for lost card entry flow diagram;

FIG. 3 presents an exemplary owner-card pairing process;

FIG. 4 presents an exemplary detailed owner-card verification process supporting the flow diagram of FIG. 3;

FIG. 5 presents a plan view of an exemplary financial card, wherein the financial card includes identifying information including a card number, card owner information, and card processing information;

FIG. 6 presents an isometric view of an exemplary portable computing device acquiring an image of the exemplary financial card;

FIG. 7 presents a schematic diagram of an exemplary misplaced card owner notification process;

FIG. 8 presents an isometric view of the exemplary portable computing device acquiring computer readable information from a computer readable element integrated into the exemplary financial card;

FIG. 9 presents a flow diagram illustrating steps of the exemplary misplaced card owner notification process;

FIG. 10 presents an exemplary article owner association tag comprising a first exemplary machine readable article identifier, wherein the first exemplary machine readable article identifier is a barcode;

FIG. 11 presents an alternative exemplary machine readable article identifier, wherein the alternative exemplary machine readable article identifier is a numeric code, the marking further comprising a Quick Read (QR code) representative of a link to a service provider's website, application, and the like;

FIG. 12 presents an alternative exemplary machine readable article identifier, wherein the alternative exemplary machine readable article identifier is a Quick Read (QR code) representative of an alphanumeric identifier;

FIG. 13 presents an isometric view of an exemplary application of the article owner association tag for use in locating a key or set of keys;

FIG. 14 presents an isometric view of an exemplary application of the article owner association tag for use in locating luggage;

FIG. 15 presents an isometric view of an exemplary application of the article owner association tag for use in locating backpacks and other bags;

FIG. 16 presents an isometric view of a modified exemplary application using an article owner association label for use in locating an umbrella;

FIG. 17 presents an isometric view of an exemplary application using the article owner association label for use in locating eyewear;

FIG. 18 presents an isometric view of an exemplary application using the article owner association label for use in locating footwear;

FIG. 19 presents an isometric view of an exemplary application integrated into a screen saver or locked configuration of the portable computing device;

FIG. 20 presents an exemplary schematic diagram applying the automatic notification process to luggage on a baggage carousel;

FIG. 21 presents an flow diagram of an exemplary article return preparation process;

FIG. 22 presents a flow diagram of an exemplary article return process;

FIG. 23 presents a flow diagram of an exemplary article return process introducing an incentive feature;

FIG. 24 presents an isometric view of an exemplary application which prints the owner association identifier onto a receipt associated with a purchase of goods;

FIG. 25 presents a flow diagram presenting steps of the exemplary goods purchase owner association and return process in conjunction with FIG. 24;

FIG. 26 presents an isometric view of an exemplary application of creating and registering a tag utilizing an automated machine;

FIG. 27 presents a flow diagram presenting steps of the exemplary owner association tag scribing and registration process in conjunction with FIG. 26;

FIG. 28 presents a schematic view of an exemplary anonymous finder-owner communication process;

FIG. 29 presents a schematic view of an exemplary scavenger hunt game employing the subject scanning application;

FIG. 30 presents an exemplary schematic diagram representative of a package pick up reminder system install in a marketplace;

FIG. 31 presents an exemplary package pick up reminder flow diagram detailing steps associated with operation of the package pick up reminder system introduced in FIG. 30;

FIG. 32 presents an isometric view of an exemplary Quick Read (QR) code automated system; and

FIG. 33 presents an exemplary Quick Read (QR) code automated system flow diagram detailing steps associated with the exemplary Quick Read (QR) code automated system introduced in FIG. 32.

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present invention teaches an object recovery process, the process including entry of information from two sources: an object finder and an object seeker. The concept is to return an object that is misplaced, wherein the term misplaced is representative of a scenario where the object becomes separated from an owner, a registered user or registrant, or any other associated party. The object can be separated from the owner by any circumstance, such as being lost, accidentally forgotten, stolen, dropped, moved by another individual, a living entity that wonders away, and any other scenario where the object becomes separated from the owner, where the owner is no longer aware of the location of the object. The owner is a broad term being representative of a party having an association with object, such as: an interest in the object, possessory rights of the object, control rights of the object, custody rights of the object, and the like.

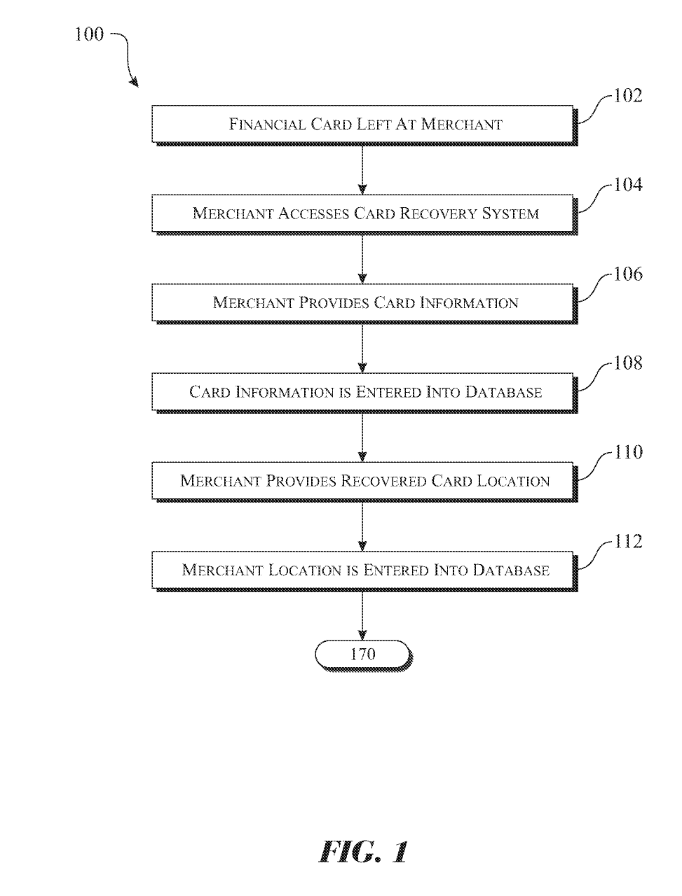

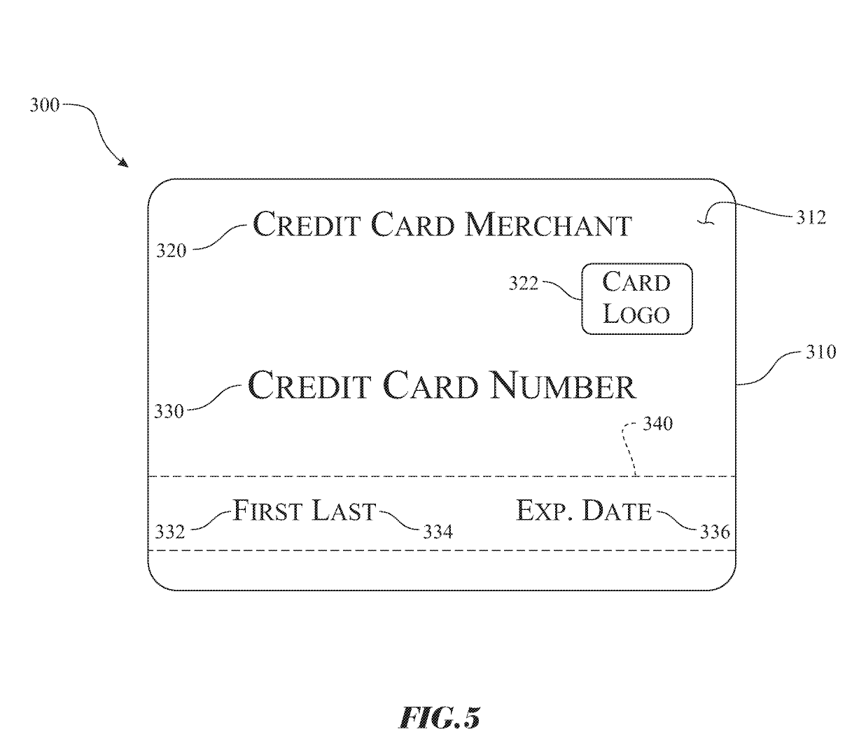

In one exemplary embodiment, the object is a financial card. The card finder enters information in accordance with a recovery card reporting process 100 as illustrated in FIG. 1. An exemplary financial card 300 is presented in a top plan view illustrated in FIG. 5. The financial card 300 can include associated information displayed upon a card primary information presenting surface 312 of a financial card substrate 310. The information can be printed upon the card primary information presenting surface 312, provided by embossing the financial card substrate 310, provided upon a digital information storage medium 340, and the like. Information can include a financial card issuing merchant information 320 and/or a financial card issuing merchant logo 322; a financial card number 330; an owner's name, including a first name 332 and a last name 334; an expiration date 336, a card security code (CSC) (not shown), and the like. The information associated with the financial card 300 can be stored and accessed through a digital information storage medium 340. The exemplary digital information storage medium 340 is a magnetic strip. Other digital information storage mediums 340 can include a passive transmission system including a digital data retention device, an electro-mechanical or contact-based communication system including the digital data retention device, and the like. One example of a passive wireless transmission system is referred to as radio frequency identification (RFID). The computing device would be in communication with a signal generator that transmits a signal. The signal excites an antenna embedded within the card. The antenna is integrated into a circuit, wherein the circuit injects data into a current and the signal is subsequently transmitted through the same or a different antenna. It is understood that there are a wide variety of solutions for conveying information from the financial card 300 to the reader, wherein the general concept of the instant invention should not be limited by the solution for conveyance therebetween.

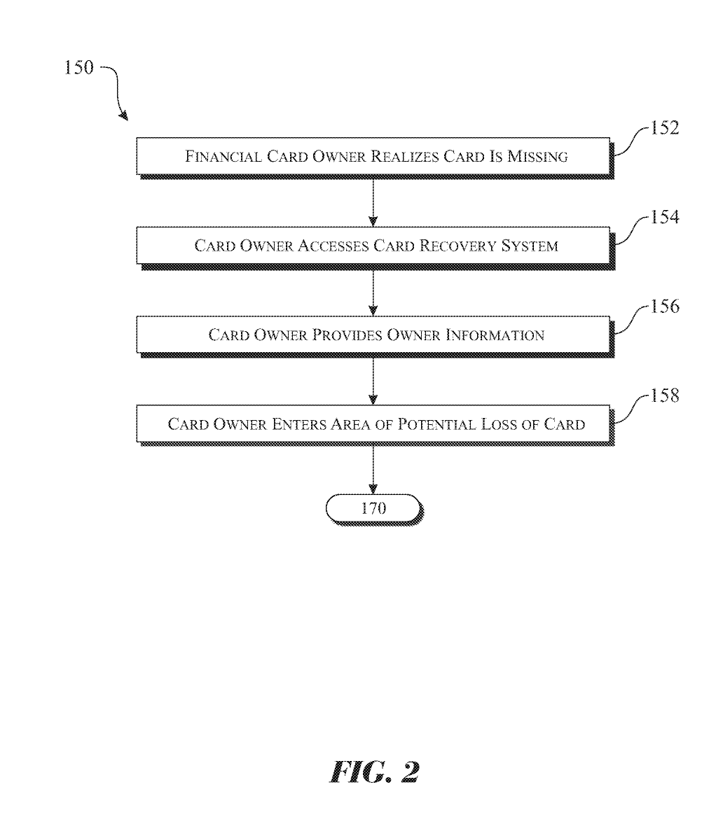

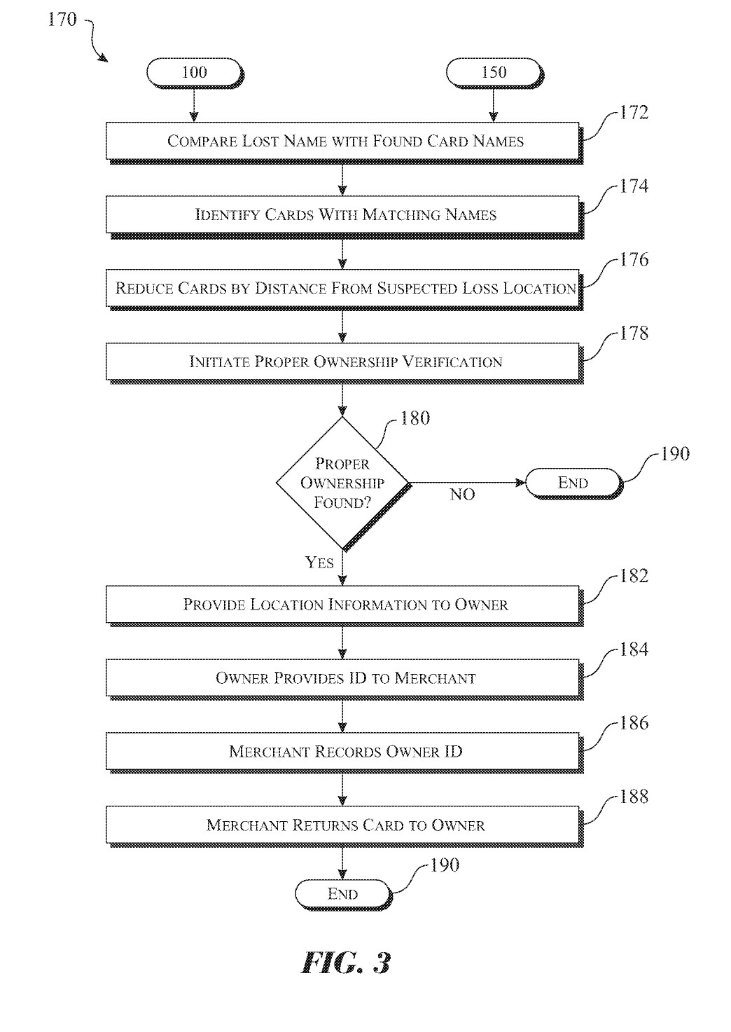

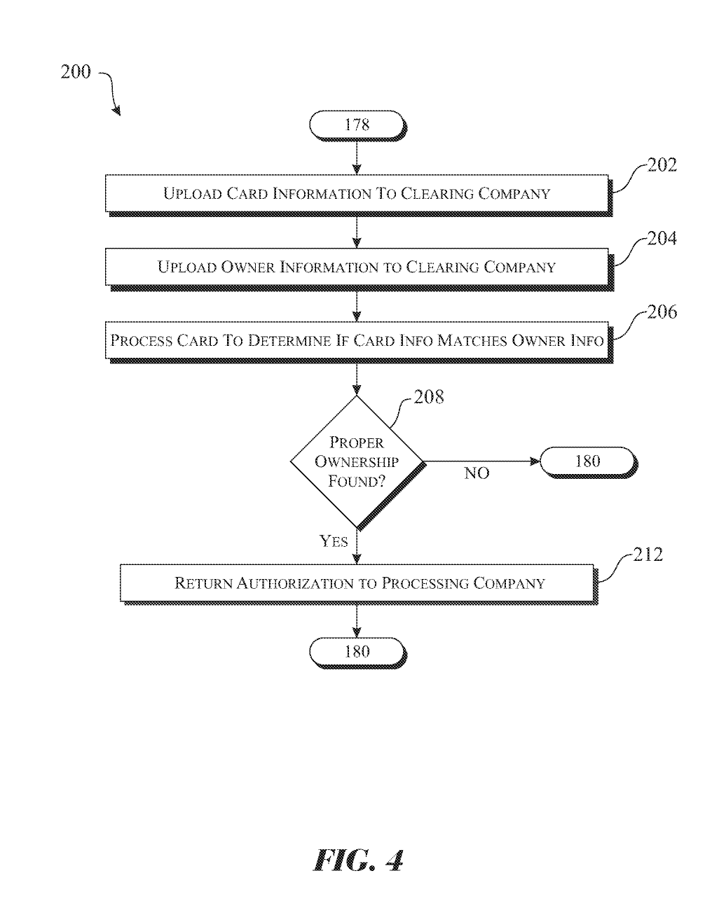

The card seeker enters information in accordance with a seeking party submission process 150 as illustrated in FIG. 2. The system utilizes information from each of the recovery card reporting process 100 and seeking party submission process 150 to determine if the found card is the card owned by the card seeker as illustrated in FIGS. 3 and 4.

The process initiates when a patron leaves a financial card at a merchant or other location (step 102) as presented in FIG. 1. The recovering party discovers the financial card and decides to attempt to return the card to the rightful owner using the present invention. The recovery party is represented as a merchant. The recovering party accesses the card recovery system (step 104) via any arranged interface system. This can include the Internet, a telephone access system, and the like. The merchant (or other party reporting the card location) can create an account, which includes the merchant location or a series of selectable storefront locations for a company. The system can direct the merchant through the data entry process, requesting the necessary information through a series of data entry steps. The recovery party enters the card information (step 106), including card owner's name, the card number, and the expiration date. The card information is recorded within a recovered card database (step 108). During the entry process, the recovery party additionally enters the location where the card resides (step 110). Should the merchant account include a plurality of locations, the merchant can select the specific location where the card is currently located. The card location is recorded within a recovered card database (step 112). It is understood that the card recovery system 104 can be provided as an application for a hosting device, represented by a portable computing device 400 (FIG. 5). The hosting device can be a networked computer, a point of sale computing device, a portable computing device, a tablet, a Smartphone, a portable computing watch, and the like. It is preferred that the hosting device includes a location determining feature. The application can utilize a location determination process 418 (FIG. 5) (such as GPS, triangulation, and the like) integrated into the portable computing device 400 to determine the current location where the misplaced card or other article resides. For fixed devices, the process can include a manually entered and retained feature to identify the location of the misplaced article.

Upon recognizing that a card 300 has been misplaced or left at an unknown location (step 152), the card owner would access the card recovery system (step 154). The card owner can ether create an account or access an existing account using any of many well known processes. The owner can provide owner information (step 156) when creating an account or any point thereafter. The account owner information would include owner name, billing address, contact information (such as telephone number (landline and/or cellular), email address, a facsimile telephone number, and the like), and other respective information. The owner can include multiple sets of information to accommodate more than one financial card 300. Should the owner's account comprise multiple sets of information, the owner can select the information related to the suspected missing card from the list of sets of information. The owner can optionally enter a most probable location where the owner believes they might have left the card (step 158). The location can be entered as a merchant, a city and state (and country if required), a longitude and latitude, and the like.

The process continues with a series of steps to determine if the misplaced card has been located, in accordance with an exemplary card locating flow diagram 170, which is detailed in FIG. 3. The data from the recovery card reporting process 100 and seeking party submission process 150 are used to match searching card owners with reported recovered cards in accordance with an owner name and card name comparison (step 172). The process returns a listing of all cards having a matching owner's name (step 174). The process can optionally sort and/or reduce the returned listing of cards based upon a distance from the location (step 176) provided by the owner. Once a listing of potential cards is created, the process then needs to narrow the listing (step 178) to the card matching the correct ownership. The process completes a series of cyclical verifications to determine if the billing address of the recovered card number matches the billing address provided by the searching owner. When a the billing address of the recovered card 300 number matches the billing address provided by the searching owner, the process determines that proper ownership is identified (step 180). The location of the recovered card 300 is provided to the owner (step 182). The owner travels to the merchant, identifies that the owner had lost a card 300 and understands the card had been recovered at that location. It is critical that the card 300 be returned to, and only to, the rightful owner. To ensure proper transfer, the owner presents some form of picture identification to the merchant (step 184) providing security for all involved. It is desirable that the merchant records the owner information (step 186) for traceability should an issue arises at a later point in time. The merchant concludes (step 190) the process by transferring the card 300 to the rightful owner (step 188).

Should the process be unsuccessful in the attempt to secure a match between the reported recovered cards 300 and the seeking owner, the process returns a message stating that the sought after card has not been reported at this time. The process can continue by comparing cards 300 to determine proper ownership for each card 300 matching the searching party's name that is reported subsequent to the initial search.

The process of narrowing the listing 178 can be completed in any of a variety of means. One such exemplary means is presented in a clearinghouse confirmation process 200 illustrated in FIG. 4. The process uploads the card number 330 to a financial clearing company (step 202). The clearing company utilizes access to a financial card database. The financial card database contains current information respective to each of the card numbers, including owner name, billing address, and expiration date. The financial card database can optionally include ownership passwords, most recent transactions, and the like. The information provided by the searching party is uploaded to the clearing company (step 204). The uploaded information can include:
a. Name of the Card Owner,
b. Number of the Recovered Financial Card,
c. Expiration Date of the Recovered Financial Card,
d. Billing Address provided by the Searching Owner, and
e. A Recovery Processing Fee.

The clearing company would process the transaction request. During the transaction process, the clearing company compares the recorded billing address associated with the card number with the billing address provided by the seeking party to determine if the card information matches the provided owner information (step 206). If the submitted components match, the clearing company reports an approved transaction 212. The approved transaction 212 verifies proper ownership of the subject card through a proper ownership determine decision step 208. The process returns with a proper ownership identified to the proper ownership has been identified (step 212). If the requested transaction utilizing the submitted card information is declined, the process is repeated with the next card of the list of potentially matching cards. In a condition where the process is unsuccessful to secure a match between any of the cards of the complete list of reported recovered cards having the seeking owner's name and the billing address submitted by the seeking party, the process returns a message stating that the proper ownership has not been identified at this time to the proper ownership identification decision step 180. The process can continue by comparing newly submitted cards to determine proper ownership for each card matching the searching party's name that is reported subsequent to the current search. Should a match occur during subsequent searches, the process can notify the seeking party 182 via any remote notification process, such as an audible conveyance using a telephone, a Short Message System (SMS) (i.e. text message), an email, posting a message on a social networking site, mailing a hardcopy letter, sending a facsimile, and the like. It is understood, as technology advances, the means for notification can advance in parallel.

The process can be enhanced by pre-registering credit cards, debit cards, and the like with the service company. The card owner can pay a fee for registration and retention of information pertaining to credit cards. The card owner can revise the submitted card information to ensure the information remains current. The system retains the pre-registered information in a pre-registered database. When information respective to a found card is uploaded to the system, the system immediately compares the information obtained respective to the newly uploaded card with card information stored within the pre-registered database to determine if there is a match. If the information respective to a found card matches a customer's card stored within the pre-registered database, the system automatically notifies the pre-registering customer.

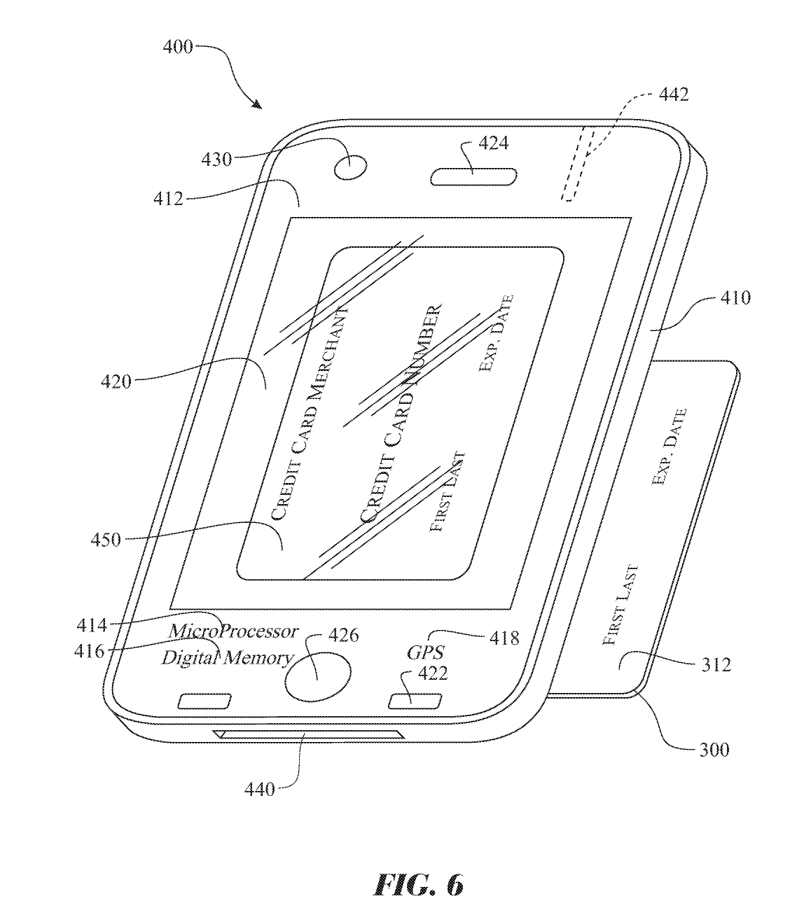

The process can include an application for Smartphones, tablets, and the like, wherein the application is installed onto the user's portable computing device 400, such as the exemplary device illustrated in FIG. 6. The exemplary portable computing device 400 is presented to introduce operational elements thereof. The portable computing device 400 includes a portable computing device housing 410 configured for supporting the remaining elements. One or more circuits are integrated into the portable computing device 400. The circuitry employs a microprocessor 414 in signal communication with at least one digital memory device 416, which collectively retain and utilize at least one instruction set for operational directions. A portable computing device display 420 is assembled to the portable computing device housing 410 enabling user interaction with the portable computing device 400. The exemplary portable computing device display 420 is a touch screen enabling a visual output for user viewing and a tactile input for the data entry. The portable computing device 400 can alternatively employ a display and a separate keyboard and/or one or more other mechanical tactile input devices 426. The portable computing device 400 includes other user interface devices, including a speaker 424 for audio output and a microphone 422 for audio input.

The instruction set and respective circuitry provides functional operation for wireless transmissions, including at least one of cellular based protocols, wireless local area network protocols commonly referred to as Wi-Fi, wide area network (WAN) protocols, and the like. The instruction set and respective circuitry can further provide functional operation for determining a location of the portable computing device 400, such as any location determining system 418. The location determining system 418 can utilize a Global Positioning System (GPS), triangulation locating processes, and the like. The selected location determining system 418 would include the respective hardware, circuitry, and software to determine the location of the device.

The portable computing device 400 can incorporate other interface devices, such as a first connector 440, a second connector 442, and at least one integrated camera 430. The first connector 440 can be employed for charging, wired signal communications, and the like. The second connector 442 can be employed for audio signal communications, including audio output and audio input. The exemplary integrated camera 430 is located in the portable computing device housing 410 to acquire images from the portable computing device viewing surface 412. It is understood that a similar integrated camera 430 can be located in the portable computing device housing 410 to acquire images from the backside of the portable computing device 400.

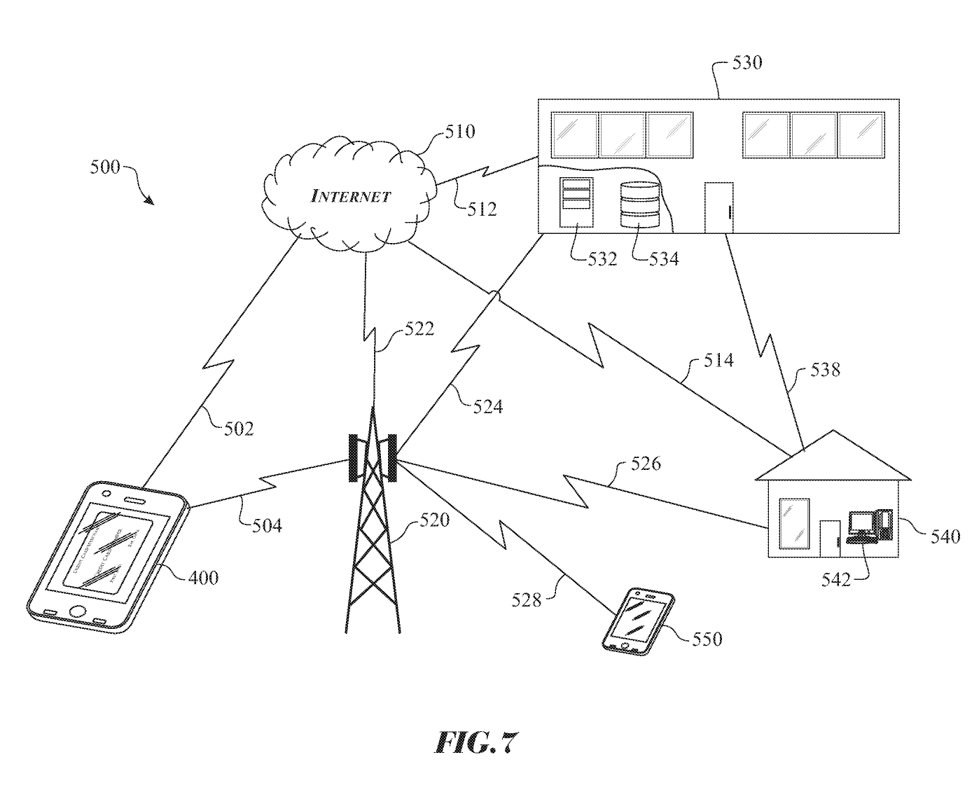

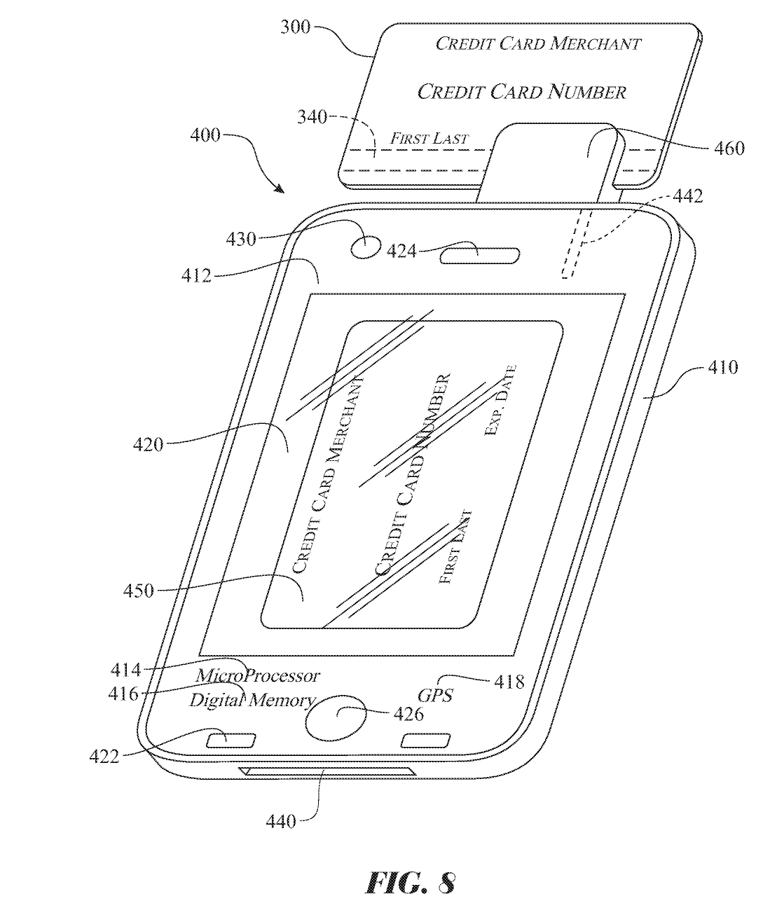

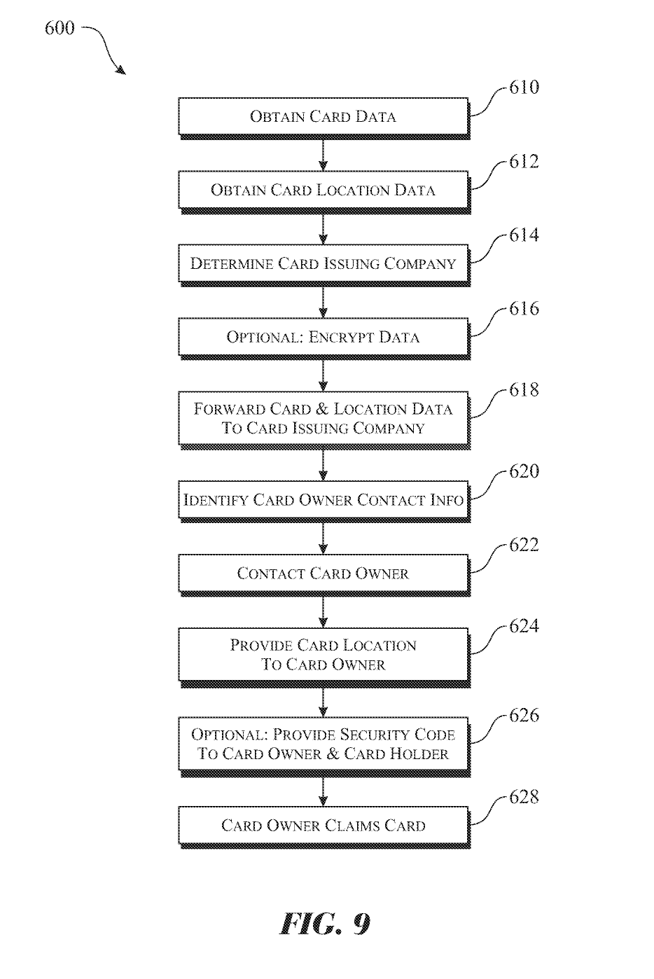

The illustration shown in FIG. 4 presents an exemplary process for acquiring an image 450 of the financial card 300. The portable computing device 400 utilizes the integrated camera 430 to capture a digital image of the financial card 300 for use in the recovery process. Details of the recovery process are initially presented in an exemplary financial card recovery schematic flow diagram 500 shown in FIG. 7. The portable computing device 400 is in wired or wireless signal communication with a card issuing company 530 using Internet communications, cellular communications, or both.

The financial cards 300 are issued by any of a number of card issuing companies 530. The application can determine the specific card issuing company 530 associated with the respective financial card 300 by any of a number of processes. The associated card issuing company 530 can be determined by decoding an encryption embedded within the financial card number 330, optically character recognition of the financial card issuing merchant information 320, obtaining an image of the financial card issuing merchant logo 322, and the like. The process would then utilize a database to determine the respective card issuing company 530 associated with the acquired information. The database can be included in the application employed by the portable computing device 400, available through the Internet 510, available through a service provider, and the like. Alternatively, the collected data can be forwarded to all card issuing companies 530, wherein each card issuing company 530 would determine if the card is associated with the specific entity.

The collected financial card information and respective location data can be transmitted to a card issuing company 530 utilizing any of a variety of data transmission protocols and communication links. The application would preferably encrypt the collected financial card information and respective location data prior to transmission of the data to a card issuing company 530.

Employing a cellular protocol, the portable computing device 400 would transmit the collected financial card information and respective location to a card issuing company 530 by way of a cellular network 520 utilizing direct communication links 504 and 524. Alternatively, the transmitted data can be transmitted using a combination of cellular protocol and Internet Protocol (IP) utilizing combined cellular and Internet communication links 504, 522, and 512 in conjunction with the cellular network 520 and the Internet 510. In another alternative communication process, the portable computing device 400 can transmit the data to the card issuing company 530 using Internet Protocol through a Wi-Fi communication interface, WAN communication interface and the like to access the Internet 510 through a locating computing device Internet communication link 502. Transmission of the data would continue to the card issuing company 530 utilizing deployed wired Internet communication links 512 and known Internet protocol addressing. In yet another Internet based communication process, the portable computing device 400 can be directly connected to a computer or other network based device and forward the data through the associated Internet communication data lines.

Upon receipt of the collected data, the card issuing company 530 utilizes a card issuing company server 532 and a respective card issuing company database storage device 534 to determine the proper owner and associated owner's contact information. The card issuing company 530, preferably using the card issuing company server 532, informs the proper card owner that the card 300 has been reported as being found and the respective location of the financial card 300 using any or all of the contact information previously provided by the card owner. The card owner can optionally establish a hierarchy for contact if multiple contact methods are provided.

The communication process would be determined based upon the contact method established by the card owner and/or the card issuing company. In a first example, the process can provide a communication to a card owner's cellular telephone 550. The card owner's cellular telephone 550 can receive an audible communication, a text message, an email message, and the like. For audible messages and text messages, the card issuing company server 532 would utilize the cellular network (via the cellular network to card issuing company cellular communication link 524 to the cellular network 520, which forwards the communication to the card owner's cellular telephone 550 via the cellular network to card owner cellular communication link 528) to convey the message. For text messages and email messages, the card issuing company server 532 would utilize the Internet 510 in conjunction with the cellular network (via the Internet to card issuing company Internet communication link 512 to Internet 510, the cellular network to Internet communication link 522 to the cellular network 520, which subsequently forwards the communication to the card owner's cellular telephone 550 via the cellular network to card owner cellular communication link 528) to convey the message.

In a second example, the process can provide the communication to a card owner's residence/business 540 using an audible communication, a facsimile communication, an instant message, an email message, a message through social media, and the like. Communication to the card owner would be completed respective to the selected method for receiving the message. Options can include transmissions through landlines, as exemplified by a card issuing company to card owner landline communication link 538, through the Internet (utilizing the Internet to card issuing company Internet communication link 512, the Internet 510, and an Internet to card owner Internet communication link 514), through the Internet 510 in conjunction with the cellular network (via the Internet to card issuing company Internet communication link 512 to Internet 510, the cellular network to Internet communication link 522 to the cellular network 520, and the cellular network to card owner landline communication link 526 to a card owner's resident computing device 542 or other suitable device within the card owner's residence/business 540), and any other suitable transmission link or link combination.

The process can requests that the card owner respond to the message notifying the card owner of the located financial card 300 and the associated location of the financial card 300. The card owner would present a photographic identification to the current card holder to ensure rightful ownership prior to returning the financial card 300 to the card owner. Alternatively or in conjunction with a photographic identification, the card owner can be provided a verification code. The verification code would also be conveyed to the party reporting the card location. The card owner is required to disclose the verification code to the current card holder to ensure rightful ownership prior to returning the financial card 300 to the card owner.

The use of an integrated camera 430 within the portable computing device 400 presents a solution utilizing elements commonly integrated within available portable computing devices 400. This solution would be available to any individual having access to a portable computing device, such as a tablet, a Smartphone, a computer and digital camera combination, and the like. Individuals in a merchant environment may additionally or alternatively employ the card data reading device 460 to obtain data from the financial card 300. The card data reading device 460 can be a magnetic strip reader, an RFID reader, a smartcard contact reader, and the like. The card data reading device 460 can be removably attached to the portable computing device 400 using an electromechanical connection, such as the first connector 440 or the second connector 442 (a shown).

A summary of a financial card recover process is presented in an exemplary financial card recovery flow diagram 600. The financial card recovery flow diagram 600 is initiated by activating an application residing upon the portable computing device 400. The application directs the user through steps to obtain data respective to the misplaced card 300 (block 610) and the location where the misplaced card is currently residing (block 612). The step of obtaining data from the card 300 (block 610) can be accomplished using any of a variety of processes. One optional process would be to take a digital image of the financial card 300 using the integrated camera 430. The application or the server would utilize optical character recognition (OCR) instruction steps to convert sections of the image into ASCII characters, preferably those understood as legible text or a combination of legible text and grammatical characters. The information would include at least a portion of the financial card issuing merchant information 320, financial card number 330, the card owner first name 332, and the card owner last name 334. The application would utilize the financial card issuing merchant information 320 and/or the financial card number 330 to determine the card issuing company (block 614). This can be accomplished by comparing the acquired and deciphered information with an index or database. The application makes use of the card issuing company information to forward the collected data to the card issuing company 530; more specifically, the card issuing company server 532 of the card issuing company 530.

In an alternative process, the application can acquire data from the financial card 300 by interrogating the digital information storage medium 340 of the financial card 300. The process for acquire data from the digital information storage medium 340 would be respective to the form factor of the digital information storage medium 340. The card data reading device 460 would include a magnetic strip reader for reading a digital information storage medium 340 provided as a magnetic strip. The card data reading device 460 would include a contact reader for reading a digital information storage medium 340 provided as a digital memory circuit comprising a contact set. The card data reading device 460 would include a near field communication for reading a digital information storage medium 340 provided as a data storage configuration comprising a proximity transceiver. It is understood that the card data reading device 460 would be adapted to interrogate and retrieve data from the digital information storage medium 340 of any suitable form factor. The application would acquire all of the information stored within the digital information storage medium 340, replicating at least a portion of the financial card issuing merchant information 320, financial card number 330, the card owner first name 332, and the card owner last name 334.

The application employs the portable computing device location identification system 418 of the portable computing device 400 or information provided by the card recovering individual to determine the location of the misplaced card 300 (block 612). The portable computing device location identification system 418 provides an automated process for determining the location of the misplaced card 300. In an alternative process, the application user can manually enter their location. The application user can establish a standard location. This would be applicable for devices used at and maintained by merchants, where the location remains constant.

The card information and the location can optionally be encrypted into a secured message (block 616). The encryption process can employ any suitable encryption algorithm.

The information is conveyed to the card issuing company 530 in any suitable manner (block 618), including those presented in FIG. 7 described earlier herein. The card issuing company server 532 receives, decodes, and utilizes the received information to determine the card owner's information (block 620). The card issuing company server 532 interrogates a database stored on the card issuing company database storage device 534 to determine the card owner's information. The process can utilize the financial card number 330 to identify the card owner's information from the database stored on the card issuing company database storage device 534. The process can utilize the card owner first name 332 and card owner last name 334 to ensure information acquired from the financial card 300 has been accurately depicted. The process would compare the provided financial card number 330, the card owner first name 332, and the card owner last name 334 with information retained by the database stored on the card issuing company database storage device 534. Once the card information has been authenticated and the card owner's information has been retrieved, the process continues by contacting the rightful card owner (block 622). The process would inform the rightful card owner that their misplaced card 300 has been recovered and where the card 300 currently resides (block 624). It is understood that the process can include steps for verification of the identity of the rightful owner of the card 300. In one verification process, the rightful owner would present a photographic identification to the recovered card holder for. In another process, the card issuing company server 532 can provide a security code to the rightful owner and the recovered card holder to ensure the card is returned to the rightful owner (block 626). The party retrieving the card would provide the recovered card holder with the security code to confirm that the party retrieving the card is the rightful card owner. In yet another option, the card issuing company server 532 can forward a digital photographic image of the rightful card owner to the recovered card holder for validation.

Once the party retrieving the card is identified as the rightful card owner, the recovered card holder returns the financial card 300 to the rightful card owner (block 628). The process can conclude by informing the card issuing company 530 that the card has been successfully returned to the rightful owner.

For security purposes, the card issuing company 530 can optionally temporarily cease any potential transactions utilizing the financial card 300 between the time when the card issuing company 530 is notified of the recovered card by the recovered card holder and the time when the card issuing company 530 is notified that the financial card 300 has been returned to the rightful owner.

In addition to the use of character uploaded from the card, the process can include questions pertaining to the appearance of the card. This would further expedite the process while enhanced the security for returning found card to the rightful owner.

Although the disclosed process submits a transaction request, it is understood that the process can simply be a verification process, excluding any fee-based transactions. Alternately, the fee can be removed to avoid any cost to the owner.

The above process is primarily subject to credit cards. It is understood the process can be adapted to any financial card, including debit cards, ATM cards, and the like. Additional card information can be submitted by the owner, such as a Personal Identification Number (PIN), password, registered bank, and the like to verification proper ownership. The owner can additionally register any card or document with the recovery processing company, such as driver's licenses, social security card, insurance card, and the like to enhance the recovery process.

Although the present invention is directed towards a portable computing device, it is understood that the concept may be applied to any computing device comprising the key elements of the present invention. The key elements include a method of knowing the location of the device, at least one elements permitting entry of the credit card information, and a communication link between the computing device and the financial card issuing merchant or other solution provider having a database and capability for contacting the card owner of the location of the misplaced card. The computing device can identify the location of the device by any suitable automated methods (as previously described) or by manual entry. The manually entered data can reside in a stored media locally on the machine. The communication link can be provided through any suitable communication protocols, including DSL, cable modem, satellite, cellular, or any other suitable data communication link.

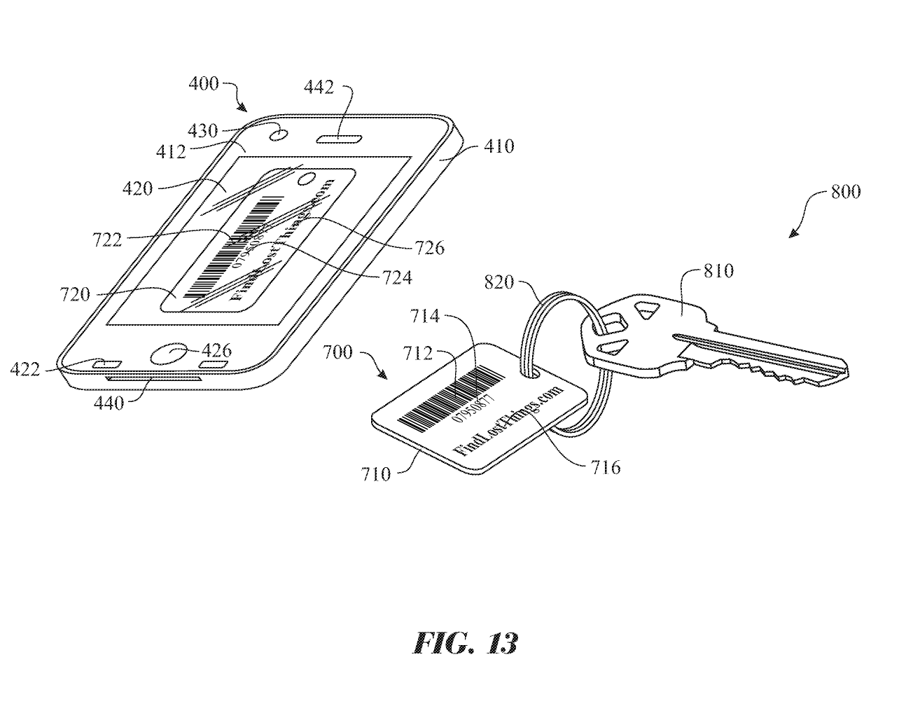

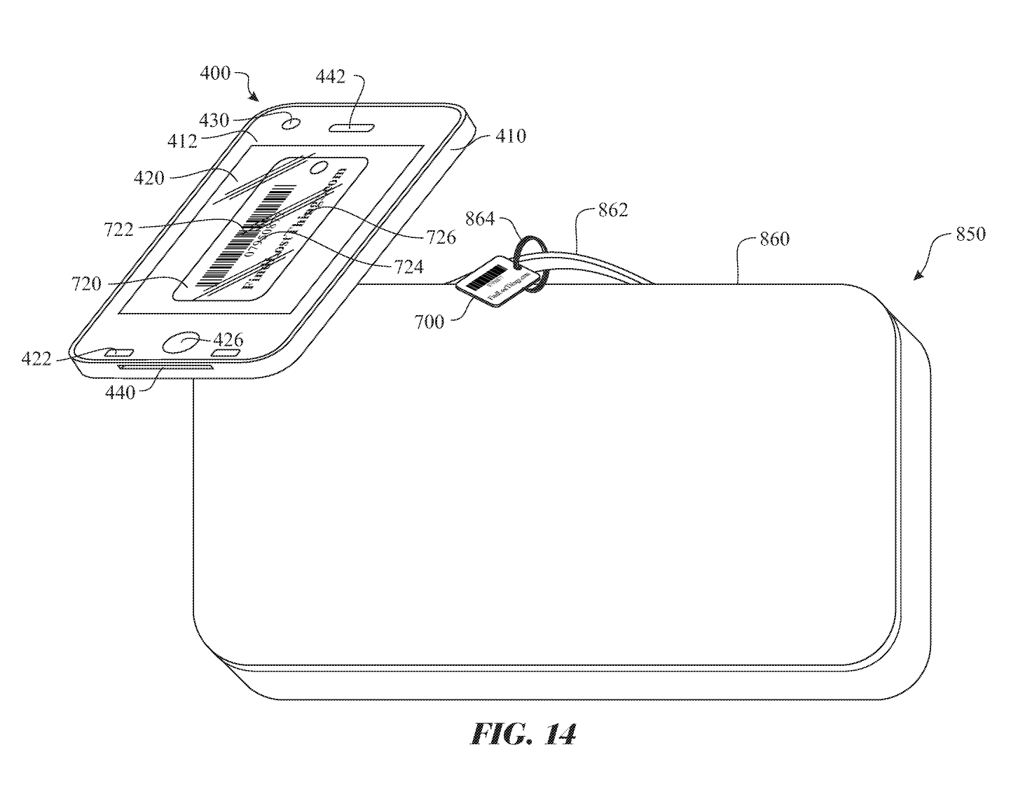

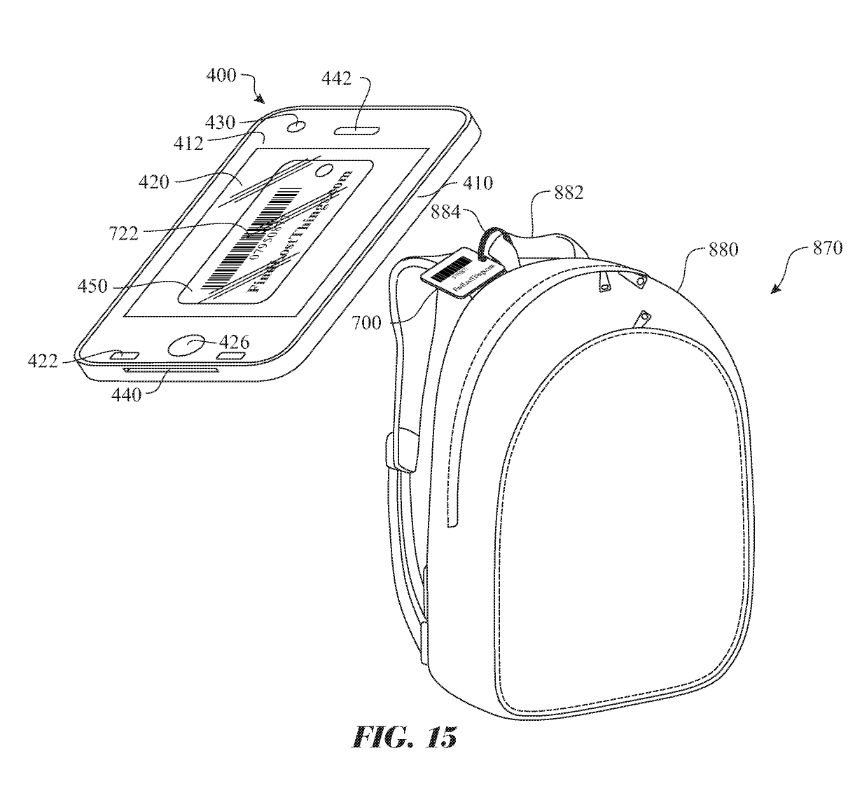

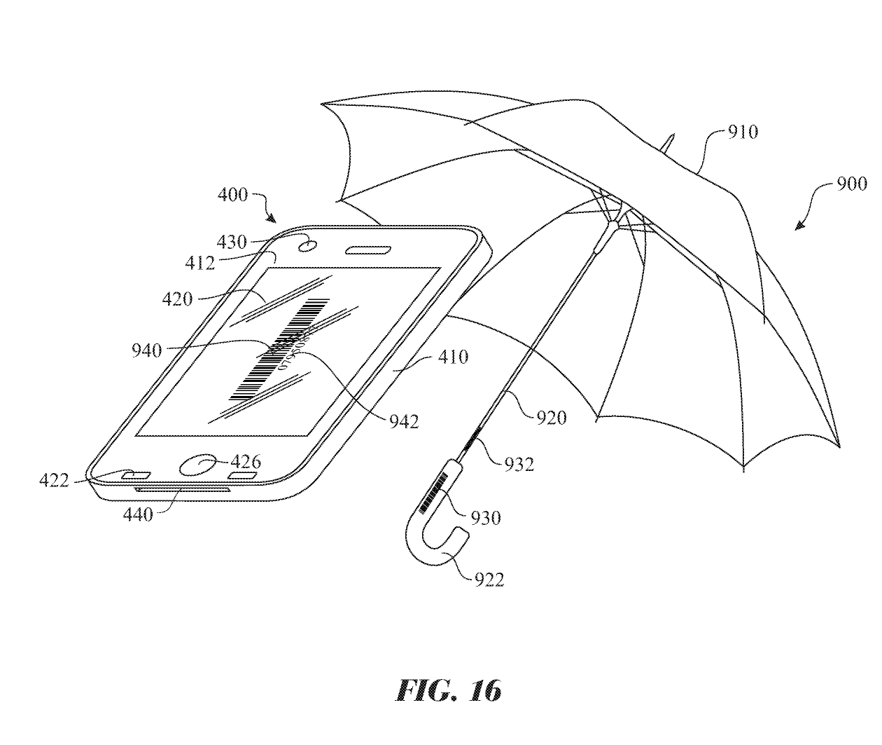

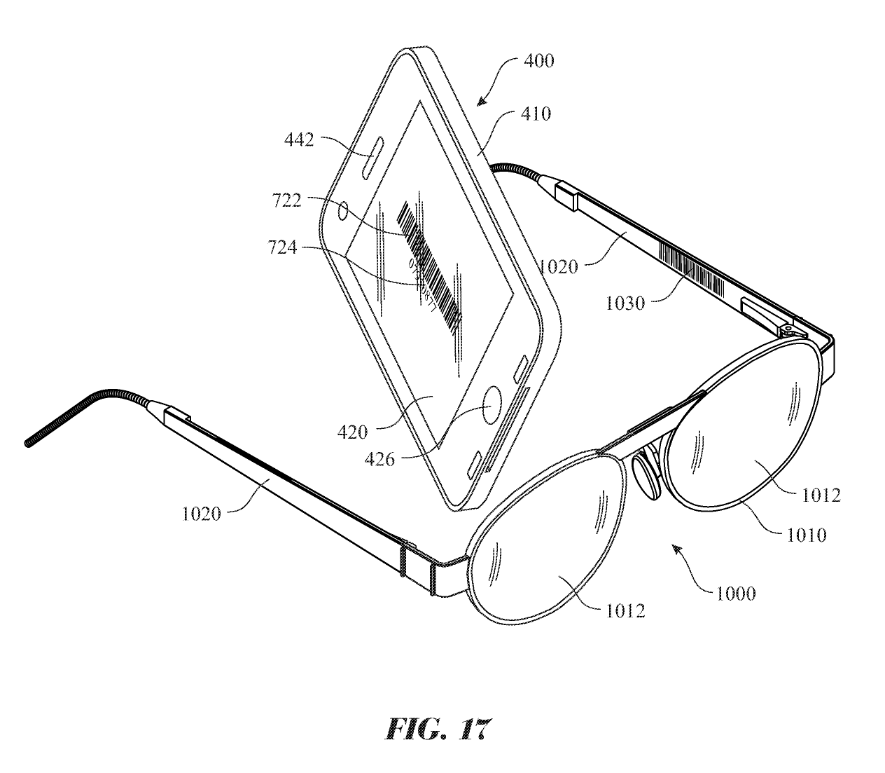

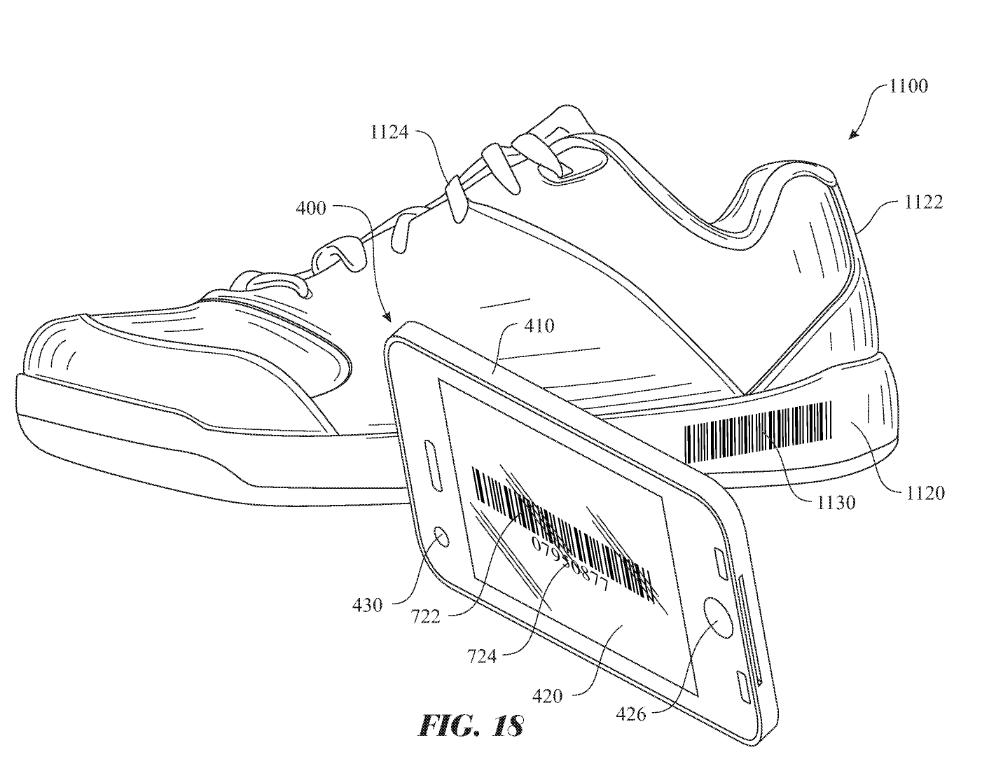

The same concept can be adapted to other personal articles, such as keys 800, as detailed in FIG. 13; luggage 850, as detailed in FIG. 14; backpacks 870, diaper bags, camera bags, purses, and the like, as detailed in FIG. 15; umbrellas, as detailed in FIG. 16; eyewear 1000, including prescription glasses, reading glasses, sunglasses, and the like, as detailed in FIG. 17; footwear, including kids wear, sneakers, sandals, and the like, as detailed in FIG. 18; and any other personal article.

The adaptation provides a device having a unique article identifier that can be captured by a portable computing device, such as a tablet, a cellular telephone (preferably a Smartphone), and the like. It is also understood that the system can employ any computing device capable to communicating with a found article notification service provider. The preferred components would include an entry or capture mechanism to acquire an article registration identifier, an entry or capture mechanism to identify a location of the found article, and a communication circuit for conveying the article registration identifier and the location of the found article to an article return service provider.

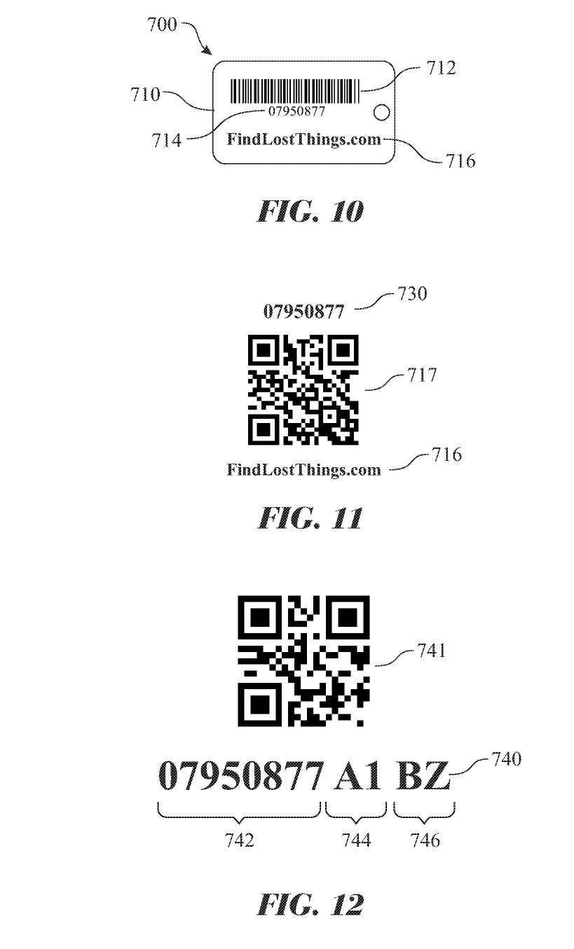

The device having a unique article identifier can be provided in any form factor compatible with an associated article location notification application. Examples include an article owner association tag 700 (FIG. 10), a hand grip located article owner association tag fastener 930 (FIG. 16), an applied article owner association tag fastener 1030 (FIG. 17), an applied article owner association tag fastener 1130 (FIG. 18), and the like. The unique article identifier is preferably provided in a machine readable format, such as a barcode format (represented by a machine readable article registration identifier 712) as shown in FIG. 10, a numeric code (represented by a numeric article identification reference 730) as shown in FIG. 11, an alphanumeric code (represented by an alphanumeric article identification reference 740) as shown in FIG. 12, and a Quick Read (QR code) (represented by an article identification Quick Read (QR) code 741) as shown in FIG. 12.

The information can be printed upon the substrate or other base supporting surface, laser etched, engraved, embossing, de-bossing, or any other method of applying or creating a machine readable image upon a surface. In an embodiment where the information is etched, ink or other contrast enhancing media can be introduced into the recessed etching or de-bossing or applied upon the embossed surface to enhance a contrast between the etched area and the base material.

When an article is located, the individual finding the forgotten or lost article is informed that the article is registered with an article return service provider by the unique article identifier. The unique article identifier can be provided in a form of a tag, a label, an inscription, and the like. Application access information 716 would preferably be presented at a location proximate the unique article identifier. The application access information 716 would identify a website, an application, and the like for directing the individual finding the forgotten or lost article to a location to download the associated application. The application access information 716 can be provided in at least one of a human readable format (as shown) and an application access Quick Read (QR) code 717, and preferably both. The associated application is preferably provided as a courtesy to the individual.

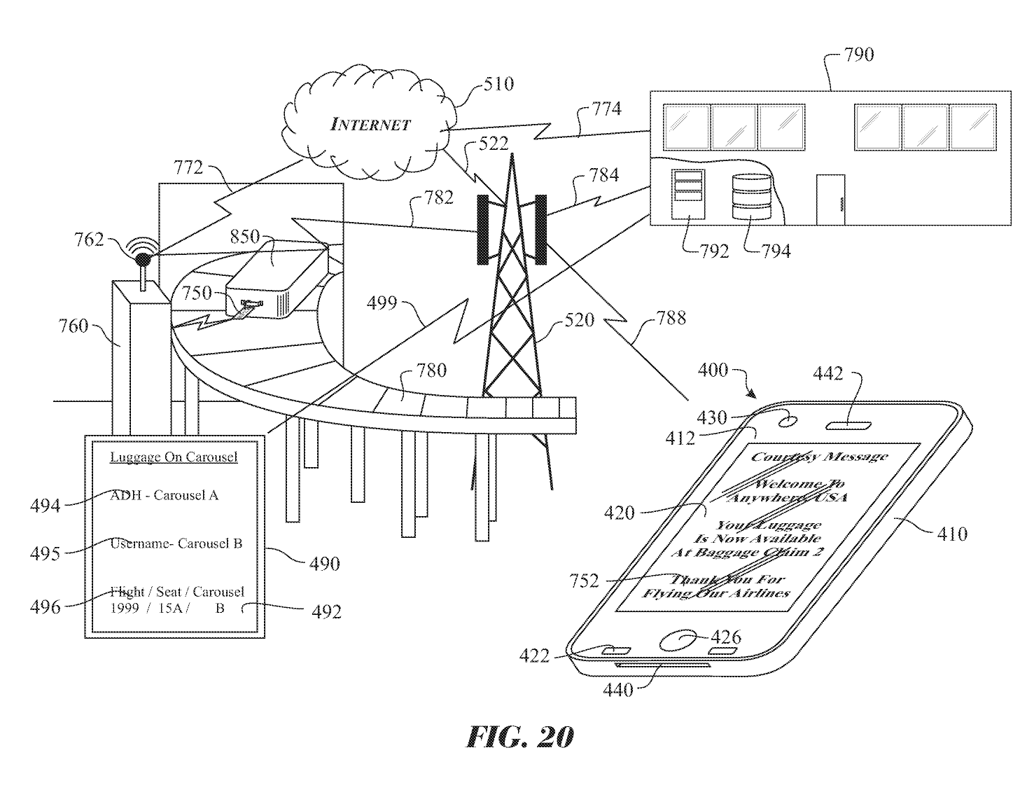

In any embodiment, the user would capture an image of the unique article identifier using an integrated camera 430 of the portable computing device 400. In an alternative embodiment, the user could manually enter the unique article identifier using a keyboard or other manual entry interface. The user would rely upon the human readable article registration identifier 714 as a reference. The portable computing device 400 deciphers the captured image (machine readable article registration identifier image 722) to determine the unique article identifier associated with the located article. The portable computing device 400 could optionally display a human readable article registration identifier image 724 for verification by the user prior to transmitting the information to the article return service company server 792 (FIG. 20) of the article return service company 790 (FIG. 20). The portable computing device 400 would transmit the unique article identifier associated with the located article and a current location of the article to the article return service provider. The article return service provider would utilize the unique article identifier to ascertain contact information associated with the rightful owner of the article. The method or methods for contacting the rightful owner can vary and would established by the rightful owner or other account holder and can include text messaging, a voice message, an email, and the like.

In one application, the article owner association tag 700 is attached to or utilized as a key ring assembly 800 as illustrated in FIG. 13. The machine readable article registration identifier 712 is displayed upon one surface or both surfaces of a tag substrate 710. A tag attachment aperture 711 is formed through the tag substrate 710 for passage of a key ring 820 therethrough. The key ring 820 provides attachment between the tag substrate 710 and one or more key 810, another key ring 820, and the like. When an owner of the key ring assembly 800 accidentally leaves the key ring assembly 800 behind, an individual finding the key ring assembly 800 would be informed that the key ring assembly 800 is registered with the article return service provider by the application access information 716. The application access information 716 can be provided as a machine readable application access Quick Read (QR) code 717. The user can scan the application access information 716 or the application access Quick Read (QR) code 717, acquiring an associated application access information image 726 in either format. It is also understood that the human readable article registration identifier 714 can be manually entered by the finding party into the portable computing device 400. A keyboard provides manual entry capability for entering information into the portable computing device 400. It is also understood that the information can be verbally conveyed to the portable computing device 400. In yet another option, the portable computing device 400 can employ Optical Character Recognition (OCR) using either a scanning function, an OCR function applied to a digital image of an object, and the like.

The portable computing device 400 would utilize the application access information image 726 to determine, access and subsequently download the associated application for returning the found item to the rightful owner.

The individual finding the key ring assembly 800 would activate the associated application and complete a series of steps as directed by the application. In one step, the application would determine the location of the portable computing device 400 using any suitable integrated location identification system, including a global positioning system (GPS), Wi-Fi based location referencing, radio signal referencing, cellular signal triangulation, and the like. In an alternative process, the application would obtain the information from the user, either by direct entry or previously stored data. In another step, the individual would capture an image of the article owner association tag 700, referenced as an article owner association tag image 720. The portable computing device 400 would decipher the machine readable article registration identifier image 722 to determine the unique article identifier associated with the key ring assembly 800. The portable computing device 400 subsequently transmits the unique article identifier associated with the located article and the current location of the located article to the article return service provider. The unique article identifier and location can be packaged in any suitable and preferably encrypted format. The article return service provider would receive the information. The article return service provider can optionally confirm receipt of the information to the transmitting device to provide an acknowledgement. The article return service provider would determine contact information associated with the rightful owner. The article return service provider would utilize the contact information associated with the rightful owner to contact the rightful owner and provide the rightful owner with the provided location of the found key ring assembly 800. The system can optionally include a step of including the name or other identifying feature of the individual that found the forgotten or lost key ring assembly 800. The article return service provider could include the name or other identifying feature of the individual to the rightful owner to aid in recovery of the forgotten or lost key ring assembly 800. The rightful owner would identify the individual finding the key ring assembly 800 by their name or other identifying feature.

The system can optionally include a step of including an identification code to both the rightful owner and the individual holding the key ring assembly 800 to increase security for the transfer of the key ring assembly 800. In another security measure, the rightful owner can present the conveyed message from the article return service provider to the individual holding the key ring assembly 800 to ensure proper ownership prior to handing over the key ring assembly 800 to the rightful owner.

In a similar manner, the article owner association tag 700 can be attached to a luggage 850 as illustrated in FIG. 14. The luggage 850 would commonly include a luggage handle 862 assembled to a luggage container body 860. In the exemplary embodiment, the article owner association tag 700 is attached to the luggage handle 862 by an article owner association tag fastener 864. It is understood that the article owner association tag 700 can be replaced by a label or any other form factor for presenting the machine readable article registration identifier 712 in any suitable format. It is understood that the article owner association tag 700 can be a planar substrate, a pocket which receives a card or other insertable and removable media, a label, a sleeve, a lock, and the like. The information can alternatively be etched into an existing tag or plate that is integral into the luggage 850, such as a branding plate and the like. The method of notifying the rightful owner or registered party of the location of the luggage 850 would follow the same process as described for returning the key ring assembly 800 as presented above.

In a similar manner, the article owner association tag 700 can be attached to a backpack 870 as illustrated in FIG. 15. The backpack 870 would commonly include a backpack handle 882 assembled to a backpack body 880. In the exemplary embodiment, the article owner association tag 700 is attached to the backpack handle 882 by an article owner association tag fastener 884. The article owner association tag 700 could be any suitable form factor such as those previously described for use with the luggage 850. The method of notifying the rightful owner or registered party of the location of the backpack 870 would follow the same process as described for returning the key ring assembly 800 as presented above. The backpack 870 is representative of any bag including a purse, a camera case, a diaper bag, and the like.

The process can be adapted for use with new purchases and applied to shopping bags. The user can carry tags and affix one tag to each shopping bag. Alternatively, if the user is registered, such as with an amusement park or theme park, the user can inform a salesperson as such when purchasing one or more items. The salesperson/cashier would enter the customer/user's information into the point of purchase system. The point of purchase system would obtain the unique article identifier associated with the customer from a database. The unique article identifier would be printed on the receipt, a label, and/or the bag. It would also be desirous to include the application access information as well.

Other options that would be applicable for theme parks include the return of misplaced or lost park access and visitor identification cards or park access and visitor identification bracelets. The system would identify the visitor identification card, bracelet, or other identifier using either a visual image of an identifying reference (such as an access card identification code) or obtaining information using near field communications, such as Radio Frequency Identification (RFID), and the like. The system can utilize a database of visitors and associated contact information to return the visitor identification card, bracelet, or other identifier to the associated visitor of visitor's family.

A hand grip located article owner association tag fastener 930 or umbrella shaft located article owner association tag fastener 932 can be utilized for applications where the article owner association tag 700 is less convenient, such as for returning an umbrella 900 as illustrated in FIG. 16. The umbrella 900 commonly includes an umbrella canopy 910 supported by a first end of an umbrella shaft 920. An umbrella hand grip 922 is assembled to an opposite, gripping end of the umbrella shaft 920. In the exemplary embodiment, the hand grip located article owner association tag fastener 930 is applied to the umbrella hand grip 922. The hand grip located article owner association tag fastener 930 can be a label, a sleeve, a printed medium, an appliqué, a decal, a laser etching, an engraving, and the like. In an alternative solution, the umbrella shaft located article owner association tag fastener 932 is applied to the umbrella shaft 920. The umbrella shaft located article owner association tag fastener 932 can be a label, a sleeve, a printed medium, an appliqué, a decal, a laser etching, an engraving, and the like. The method of notifying the rightful owner or registered party of the location of the umbrella 900 would follow the same process as described for returning the key ring assembly 800 as presented above. The portable computing device 400 would capture an image of the article owner association tag fastener 930 or the umbrella shaft located article owner association tag fastener 932, identified as a machine readable article registration identifier image 940. The portable computing device 400 could optionally display a human readable article registration identifier image 942 for verification by the user prior to transmitting the information to the article return service company server 792 of the article return service company 790. The article return service company server 792 would be in signal communication with an article return service company database storage device 794. The data and associated history can be transferred between and stored on the article return service company database storage device 794.

An applied article owner association tag fastener 1030 can be utilized for returning eyewear 1000 as illustrated in FIG. 17. The eyewear 1000 commonly includes a pair of lens 1012 inserted into an eyewear frame 1010. A left temple 1020 and a right temple 1020 extend reward from a left and right side of the eyewear frame 1010 respectively. The left temple 1020 and the right temple 1020 provide sufficient surface area for application of the applied article owner association tag fastener 1030. The applied article owner association tag fastener 1030 can be a label, a sleeve, a printed medium, an appliqué, a decal, a laser etching, an engraving, and the like. The applied article owner association tag fastener 1030 would be applied to an interior surface of the temple 1020 to maintain aesthetics of the eyewear 1000. The method of notifying the rightful owner or registered party of the location of the eyewear 1000 would follow the same process as described for returning the umbrella 900 as presented above.

An applied article owner association tag fastener 1130 can be utilized for returning footwear 1100 as illustrated in FIG. 18. Footwear 1100 is commonly lost by children. Particularly when the child is traveling in a stroller. The footwear 1100 commonly includes a footwear upper 1122 joined to a footwear sole 1120. The footwear 1100 can additionally include footwear laces 1124 for opening and closing an opening along a frontal portion of the footwear upper 1122. The applied article owner association tag fastener 1130 can be a label, a printed medium, an appliqué, a decal, a laser etching, an engraving, and the like. An applied article owner association tag fastener 1130 would be applied to each of a pair of footwear 1100. The applied article owner association tag fastener 1130 would be applied to an exterior surface of the footwear sole 1120 to maintain aesthetics of the footwear 1100. The method of notifying the rightful owner or registered party of the location of the footwear 1100 would follow the same process as described for returning the umbrella 900 as presented above.

In one exemplary deployment of the system, a captive business, such as a theme park, a car rental agency, an airline, a cruise ship, and the like, would register their customer. The captive business would provide the customer with one or more article owner association tags 700 in any suitable format, such as tags, stickers or labels, and the like for attachment to any article.

In another exemplary deployment, articles can be manufactured having a pre-established unique article identifier provided thereon. The pre-established unique article identifier would be registered with the article return service provider to ensure that the article identifier remains unique.

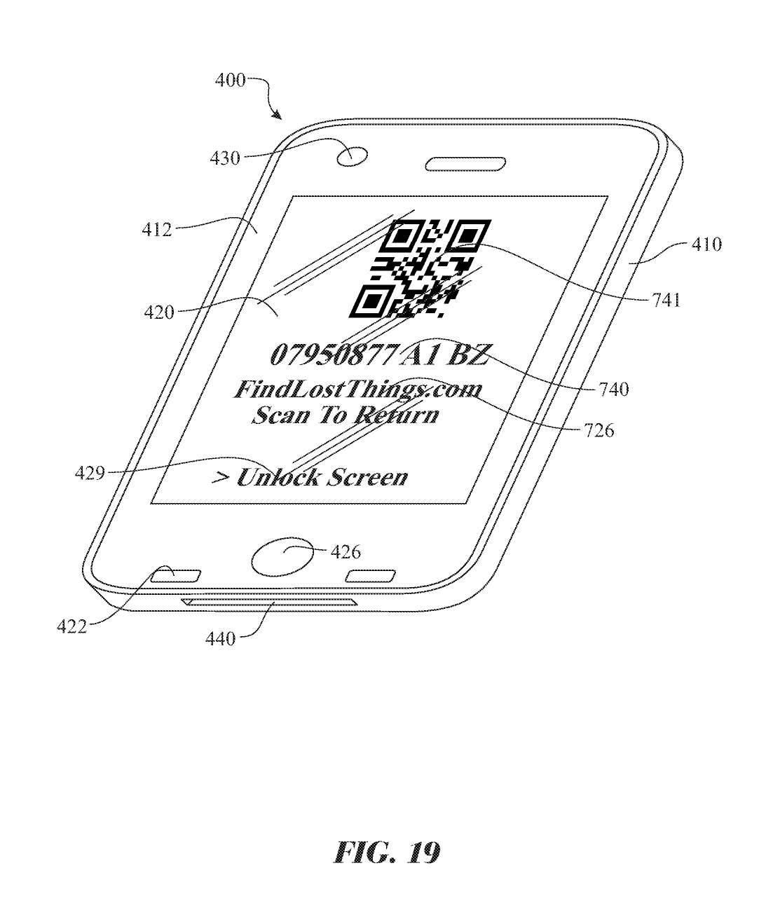

Portable computing devices 400 introduce a unique capability. The portable computing devices 400 can include an instruction set to display information associated with the article return/pickup reminder service company 790 when the portable computing device 400 is placed into a locked mode, as illustrated in FIG. 19. When placed into a locked mode (as indicated by a screen lock indicator 429), the portable computing device 400, the portable computing device 400 would display an article identifier that is registered with the article return/pickup reminder service company 790. The article identifier can be presented in any suitable format, including at least one of: an article identification Quick Read (QR) code 741, an article identification bar code (not shown), a numeric article identification reference (not shown), and an alphanumeric article identification reference 740. The portable computing device 400 would also display information directing a person that finds the misplaced portable computing device 400 to use the associated application, website, and the like to notify the rightful owner or other registered party of the location of the portable computing device 400. This can include an application access information image 726.

The above processes and associated articles are directly to scenarios where an individual would accidentally left behind.

Certain scenarios would offer proactive notification to the rightful owner. One example is a luggage 850 delivery on a luggage claim conveyor 780, as illustrated in the exemplary embodiment shown in FIG. 20. Luggage 850 would be placed upon the luggage claim conveyor 780 for delivery to the luggage owner. A passive wireless transceiver 750 would be attached to the luggage 850. The passive wireless transceiver 750 includes any active or passing transceiver embedded therein. The preferred transceiver is a passive Radio Frequency Identification (RFID) transceiver. A luggage identification system 760 is installed at the initial delivery segment of the luggage claim conveyor 780. As the passive wireless transceiver 750 passes the luggage identification system 760, the luggage identification system 760 emits an exciter transmission from an active wireless transceiver 762. The exciter transmission induces a current within the passive wireless transceiver 750. The passive wireless transceiver 750, in turn, emits an encoded signal transmitting the unique article identifier to the luggage identification system 760. The luggage identification system 760 conveys the unique article identifier to an article return service company 790 by any communication link available. In one process, the luggage identification system 760 conveys the unique article identifier to the luggage identification system 760 through the cellular network 520 by way of a luggage identification system and Cellular network communication link 782 and an article return service provider and Cellular network communication link 784. In an alternative process, the luggage identification system 760 conveys the unique article identifier to the luggage identification system 760 through the Internet 510 by way of a luggage identification system and Internet communication link 772 and an article return service provider and Internet communication link 774. The article return service company server 792 of the article return service company 790 would process the unique article identifier, identify the rightful owner, and notify the luggage owner that the luggage 850 has been placed upon the luggage claim conveyor 780. The message can be transmitted to the portable computing device 400 through the Internet 510 by way of the article return service provider and Internet communication link 774, through the cellular network 520 by way of the article return service provider and Cellular network communication link 784 and portable computing device and Cellular network communication link 788, or any combination thereof. Upon receipt of the message, the portable computing device 400 displays a luggage owner notification 752 informing the user that their luggage 850 was just placed upon the luggage claim conveyor 780.

Alternatively, the system can notify the luggage owner by transmitting a message from the system 792 to a notification monitor 490. The notification monitor 490 would present information on a notification monitor display 492 of a notification monitor 490. The information can be presented using any encrypted association to respect a privacy of the luggage owner. Examples include an initial based notification 494, a username based notification 495, and a flight and seat based notification 496. It is understood that any encrypted association can be utilized by the system. The luggage owner can submit a specific encrypted association to be presented upon the notification monitor 490 when configuring their account information.

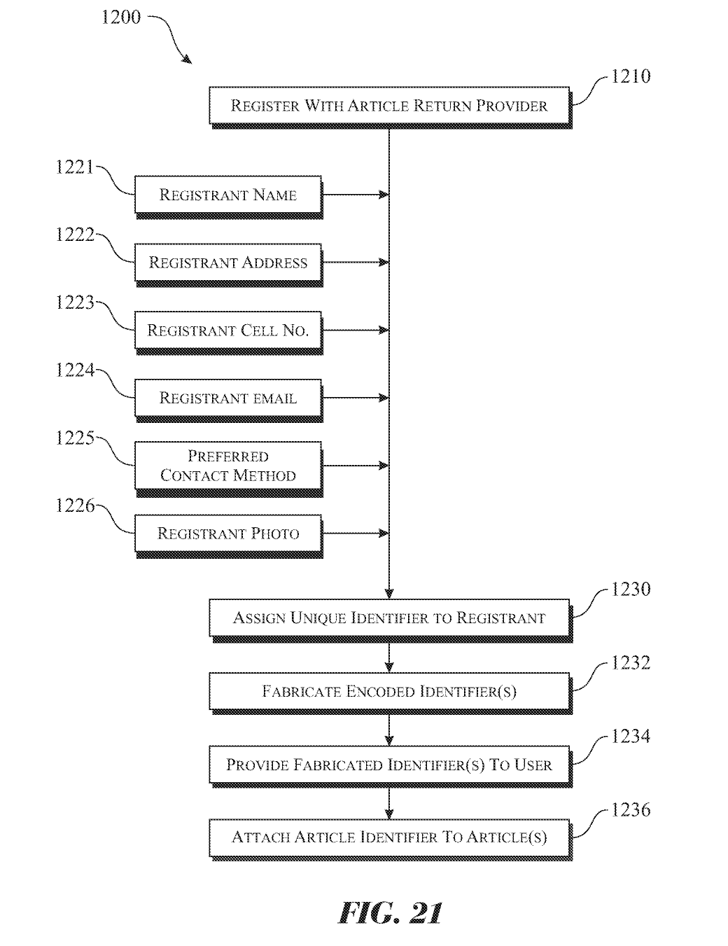

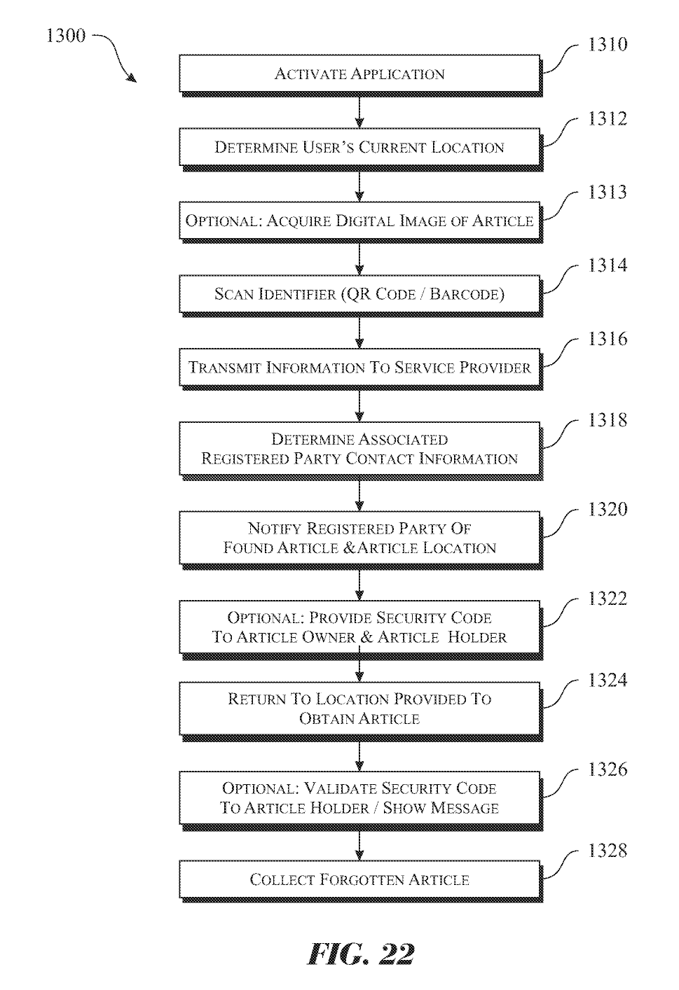

The process requires completion of various preparatory steps, which are illustrated in an exemplary article return preparation process flow diagram 1200 presented in FIG. 21. The process initiates with the rightful owner or a representative establishing an account and registering with the article return service provider (step 1210). The registration process directs a registrant through steps for entering pertinent information, such as a registrant's first and last name 1221, a registrant's address 1222, a registrant's cellular telephone number 1223, a registrant's email address 1224, identification of a preferred contact method 1225, and optionally a photograph of the registrant 1226. The registrant can establish a plurality of members, and preferably identifying each member of the group by name. The registrant can additionally enter descriptions of specific articles. The registrant can associate each article with a specific member or members of the group to provide target notification. Although the examples include a cellular telephone number (for text messages and voice messages) and an email address (for email communications), it is understood that any suitable contact method be provided. The process would establish a unique registration number that associates the registrant with the article or articles (step 1230). Each article identification tag 700 or article identification label 930, 932, 1030, 1130 would include the unique registration number. The unique registration number can be enhanced, as detailed in FIG. 12. Each article identification tag 700 or article identification label 930, 932, 1030, 1130 could include a family reference index identifier 742, and at least one of a family member identifier 744 and an article description identifier 746. Each registration could include a group of members. The members could include family members or other individuals associated with the registration. The family member identifier 744 would identify which family member or specific individual is associated with the specific article. Similarly, the article description identifier 746 would provide an association with a specific article description, such as keys 800, luggage 850, backpacks 870, camera bags, purses, wallets, shopping bags, umbrellas 900, eyewear 1000, footwear 1100, and the like. The system would generate article identification tags 700 and/or article identification labels 930, 932, 1030, 1130 based upon the information provided. The article identification tags 700 and/or article identification labels 930, 932, 1030, 1130 can be provided in any of a variety of manners. The article identification tags 700 and/or article identification labels 930, 932, 1030, 1130 can be printed by the service provider and mailed to the registrant, printed by the registrant, etched by a manufacturer, created as a marked pendant, and the like. In yet another embodiment, the unique registration number can be printed upon a receipt and the receipt would be stapled to a shopping bag. It is understood that the unique registration number can be applied to any suitable identifier for attachment or use in conjunction with an article. Once fabricated, the article identification element or elements are provided to the registrant (step 1234). The registrant would attach the article identification element to the respective article (step 1236). It is understood that the article identification element may be included with the article during the manufacturing process. In this case, the manufacture would pre-register the specific manufacturer provided unique registration number with the article return service provider. The registrant would record the specific manufacturer provided unique registration number with their account. In this case, the specific manufacturer provided unique registration number could include a prefix identifying the manufacturer, thus simplifying the unique numbering system.

Once the preparation processes are complete, the system enables immediate notification of a found article location to the rightful owner. The steps of the process are presented in an article return process flow diagram 1300 presented in FIG. 22. Upon finding an article, the individual would recognize that the article is registered with the article return service provider by way of the article identification tag 700 and/or article identification label 930, 932, 1030, 1130 attached thereon. The article locating individual would download, install, and activate the application (step 1310). The installation process can include a step of providing user information to the system. This could include information helpful in the article return process. The user information or other recovery assisting information can include any of the following: a name of the user/article recovery individual, a photograph of the user, an address of the location, a photograph of the location, a graphical map identifying the location of the article, a satellite image identifying the location of the article, and the like. The location and associated images can be obtain using global positioning satellite (GPS) information, longitude and latitude information, and the like in conjunction with available graphical maps and/or satellite imagery. If the system is associated with a corporation or other operating entity, theme park, and the like, the system can access a company or operating entity database, using the employee information to obtain the employee name, photograph, and/or other identifying information. The application would identify the location of the article (step 1312) based upon the assumption that the article is in the same location as the portable computing device 400. The location can be determined automatically by a global positioning system (GPS), a Wi-Fi positioning system, a beacon positioning system, a cellular network locating system, or manually, by entry of the location by the user or from a pre-established user location (for applications such as merchants). A digital image of the found article can be acquired using the camera 430 integrated into the portable computing device 400 (step 1313). The article locating individual would enter the unique registration number/identifier into the portable computing device 400. A preferred method would be by capturing an image of the article identification tag 700 and/or article identification label 930, 932, 1030, 1130 attached to the article using an integrated camera 430 integrated into the portable computing device 400 (step 1314). The captured image can be deciphered and presented on the display of the portable computing device 400 to the user in a human readable format for confirmation. The unique registration number/identifier associated with the article, the optional digital image of the found article, and the reported current location of the article are forwarded to the article return service provider (step 1316). The article return service provider determines the registration party contact information associated with the unique registration number/identifier provided by the article locating individual (step 1318). The article return service provider notifies the rightful owner of the found article and the reported current location of the article (step 1320). The notification can optionally include a security code (step 1322). The security code would be transmitted to both the rightful owner and the article locating individual (step 1322). The rightful owner would return to the reported current location of the article (step 1324). Upon arrival, the rightful owner would present the security code to the article locating individual (step 1326). Alternatively, a photo of the rightful owner can be provided to the article locating individual to confirm rightful ownership. The located article is returned to the rightful owner (step 1328).

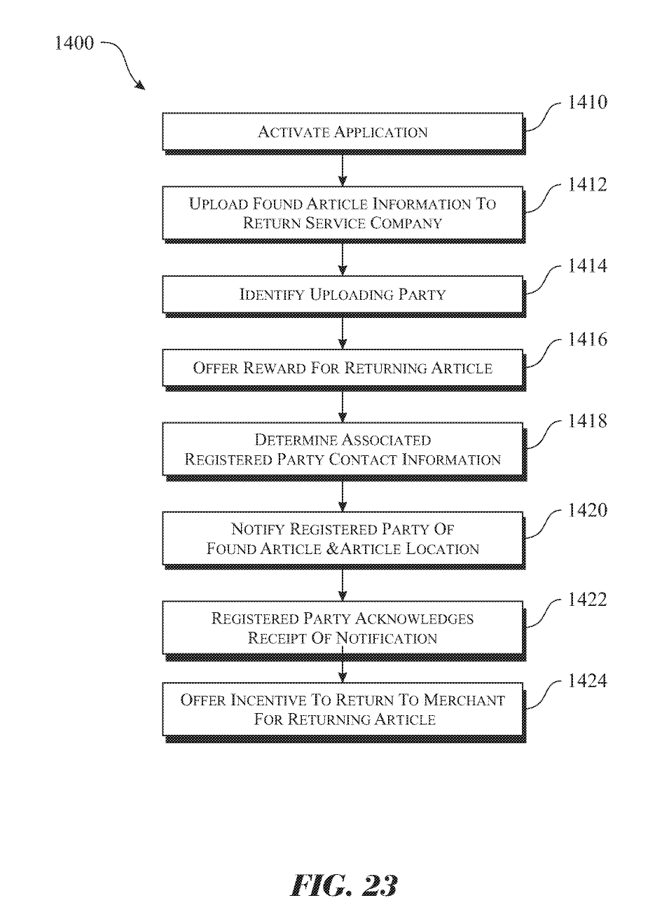

The process can be enhanced with an introduction of incentives and/or rewards as demonstrated in an article return and incentive process flow diagram 1400 presented in FIG. 23.

The article locating individual would download, install, and activate the application (step 1410). The unique registration number/identifier associated with the article and the reported current location of the article are forwarded to the article return service provider (step 1412). The article return service provider identifies the article locating individual (step 1414). The article return service provider forwards a reward offer to the article locating individual as a courtesy for providing information associated with the found article (step 1416). The reward offer can be associated with the location where the article was found, a discount coupon, a gift value, or any other incentive. The reward can be analogous with advertising, providing revenue to the article return service provider.

The article return service provider determines the registration party contact information associated with the unique registration number/identifier provided by the article locating individual (step 1418). The article return service provider notifies the rightful owner of the found article and the reported current location of the article (step 1420). The notification can optionally include a security code (step 1322). The rightful owner would acknowledge the notification of the found article and current location thereof (step 1422). Upon receipt of the acknowledgement, the article return service provider would provide an incentive to the rightful owner to return to the merchant that found the article (step 1424). It is understood that the incentive can be any incentive, including the associated merchant, a different merchant, wherein the incentive is provided in a form of a discount coupon, a gift value, or any other incentive. The incentive can be a reward provided by the article owner. The system can include a listing of optional financial amounts for the reward. One example of a listing of optional financial amounts for the reward can be $1, $2, $3, $5, $10, enter your own amount. The article locating party can either accept the reward or arrange for the reward to be made as a donation to a non-profit organization. The arrangements can be established when configuring an account, modified after the initial creation of the account, or upon receipt of the reward.

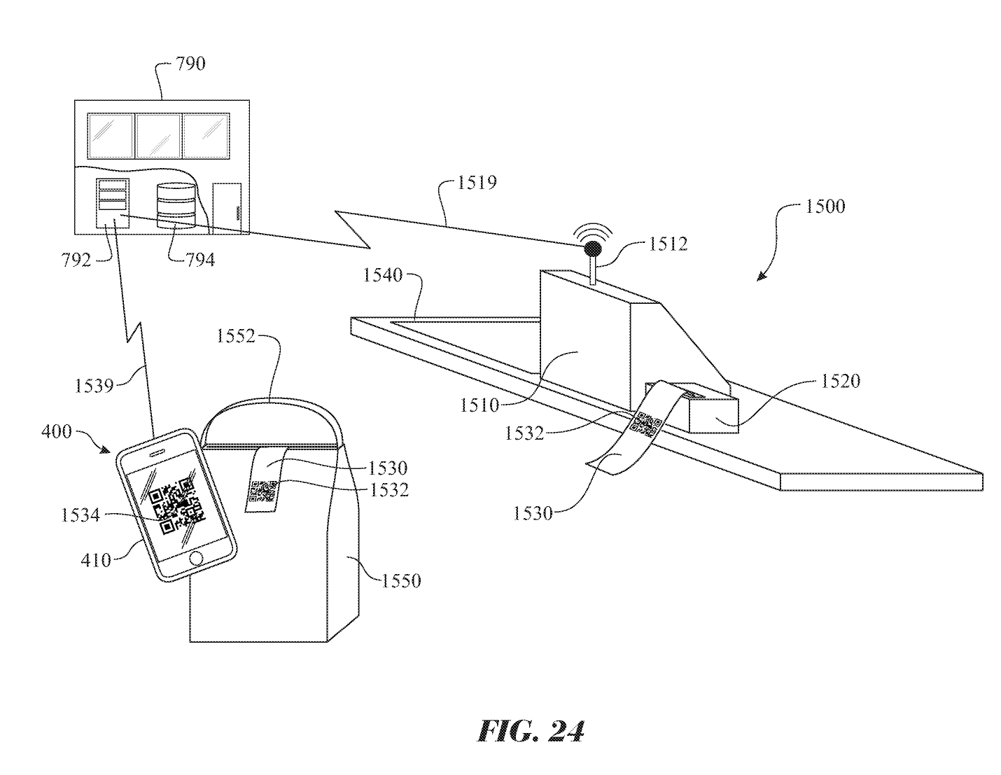

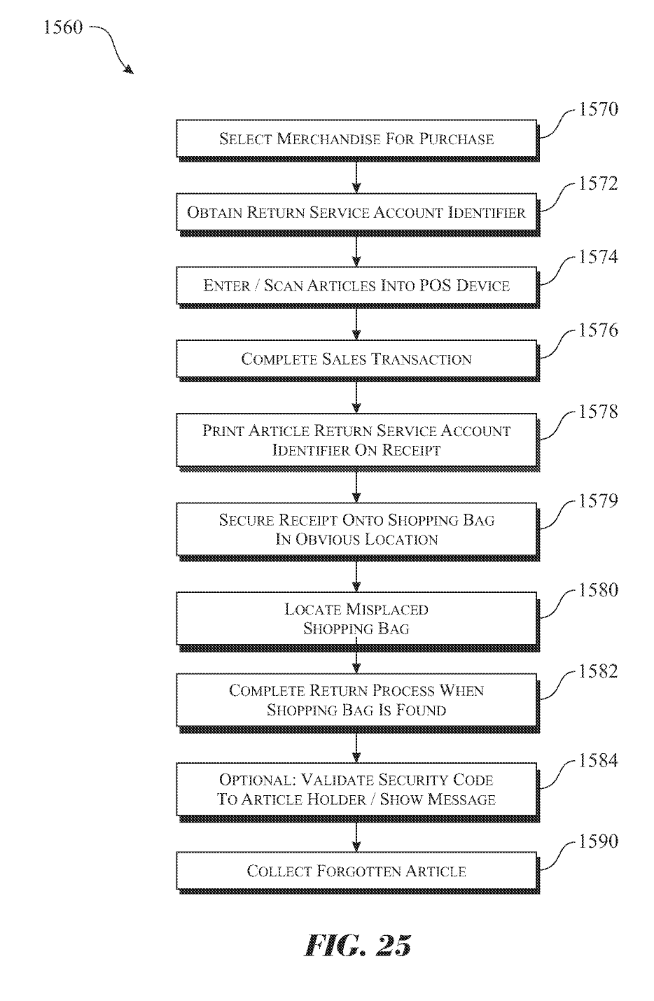

The article return service can be applied to new purchases, as introduced in the exemplary schematic diagram illustrated in FIG. 24 and described in a goods purchase owner association process flow diagram 1560 presented in FIG. 25. The concept and service can be adapted to provide a return offering of misplaced purchases by introducing the process into the purchase transaction steps. When a customer is purchasing goods from a merchant, the transaction is commonly completed at a goods transaction completion station 1500 using a point of sale (POS) system 1510. The goods transaction completion station 1500 includes a transaction station countertop 1540, which provides a sufficient workspace and supports all of the equipment necessary for completing the transaction, including the point of sale (POS) system 1510, a point of sale (POS) printer 1520 in signal communication with the point of sale (POS) system 1510, a point of sale (POS) communication subsystem 1512 in signal communication with the point of sale (POS) system 1510, one or more scanners (not shown) in signal communication with the point of sale (POS) system 1510, and any other supporting equipment.

Details of the process for adapting the process for use in conjunction with purchases initiates with a step of selecting or collecting merchandise from a merchant for purchase (step 1570). The customer would bring the merchandise to the goods transaction completion station 1500 and depending upon the size of the merchandise, place the reasonably sized merchandise onto a countertop of the transaction station countertop 1540. The customer would provide the sales clerk with information to access the customer's article return account (step 1572). This can be accomplished using any suitable process, including verbally conveying the customer's article return account information, such as the customer's article return account identifier (number), a telephone number, email address, residence address or any other identifying data point associated with the customer's article return account; scanning an article return account card; wirelessly communicating the article return account information between the portable computing device 400 and the point of sale (POS) communication subsystem 1512, and the like. The point of sale (POS) system 1510 communicates with the article return service company 790 by way of a point of sale and return service provider server communication link 1519. The article return service company 790 can generate a unique purchase registration identifier and convey the purchase registration identifier to the point of sale (POS) system 1510 via the point of sale and return service provider server communication link 1519.

During the process, the sales clerk manually enters product/pricing information or scans the Universal Product Code (UPC) of each item into the point of sale (POS) system 1510 (Step 1574). Upon completion of entry of each product being purchased, the sales clerk completes the sales transaction (step 1576). The point of sale (POS) system 1510 collects, generates and formats information to be printed upon the transaction receipt 1530. The desired information is communicated to the point of sale (POS) printer 1520. The point of sale (POS) printer 1520 prints the transaction receipt 1530 (step 1578). The machine readable purchase registration identifier 1532 is included as one of the items printed in the transaction receipt 1530. The purchased items are placed into a shopping bag 1550. It is noted that the shopping bag 1550 may include a shopping bag handle 1552 to aid in transporting the purchased items. The sales clerk, customer, or other person preferably secures the transaction receipt 1530 onto a shopping bag 1550 into an obvious location as shown in the exemplary illustration (step 1579).

At times, the customer may accidentally leave the shopping bag 1550 behind. A finding party locates the misplaced or accidentally forgotten shopping bag 1550 (step 1580). The finding party would complete the steps for returning the accidentally forgotten shopping bag 1550 to the rightful owner (step 1582). The steps would be similar to those presented in the article return process flow diagram 1300. The finding party would use the portable computing device 400 to obtain the purchase registration identifier from the transaction receipt 1530. This can be accomplished by scanning the machine readable purchase registration identifier 1532, manually entering a human readable version of the machine readable purchase registration identifier 1532, using optical character recognition (OCR) of the human readable version of the machine readable purchase registration identifier 1532, and the like. The portable computing device 400 could optionally display a machine readable purchase registration identifier image 1534 in at least one of human readable format and machine readable format before, during and/or after scanning. The portable computing device 400 would automatically obtain the location where the transaction receipt 1530 is scanned and forward the information to the article return service company 790 by way of a finder's portable computing device and return service provider server communication link 1539. The process can print a plurality of transaction receipts 1530 when the further comprising a step of printing multiple transaction receipts 1530, each copy of the transaction receipt 1530 comprising the package identifier 1532 when purchased articles from a single transaction are placed into multiple packages 1550. The process can optionally include one or more security measures. The process can provide both parties a security code. Upon arrival, the rightful owner would present the security code to the article locating individual (step 1584). Alternatively, a photo of the rightful owner can be provided to the article locating individual to confirm rightful ownership. The located article is returned to the rightful owner (step 1590). This system provides a solution for newly purchased items without any extraneous effort by the merchant and/or the return service provider's client.

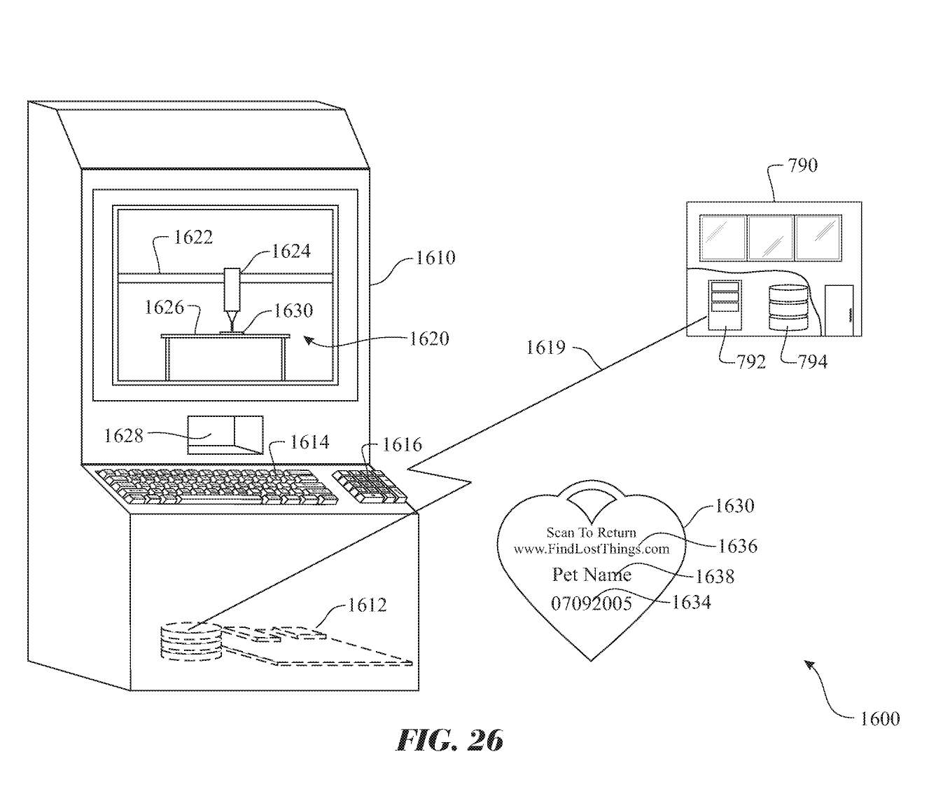

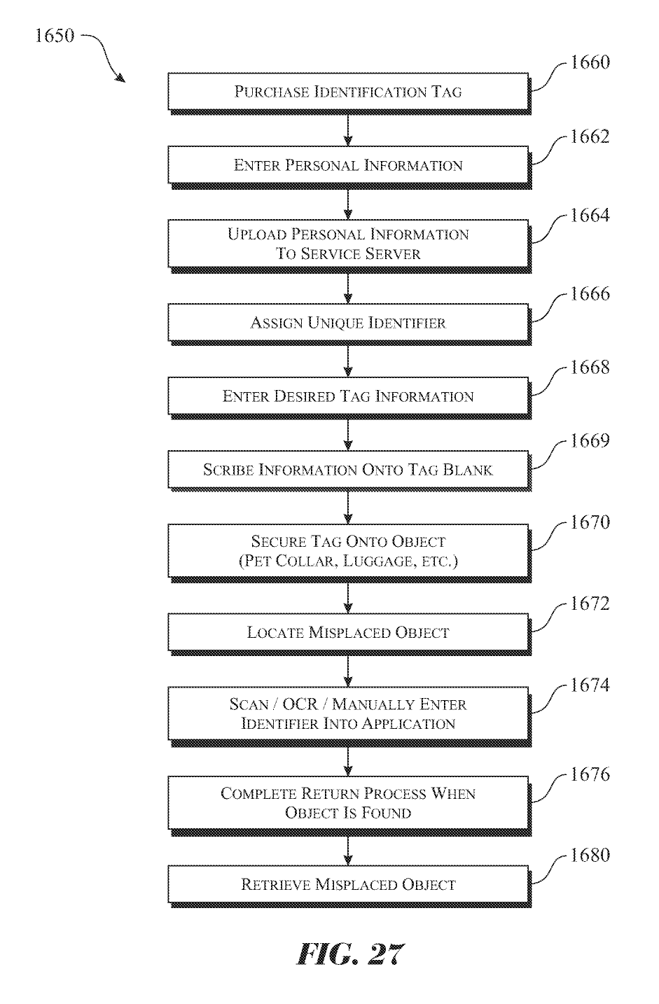

The article return service (represented as a tag customization system 1600) can be applied to automated tag scribing machines, as introduced in the exemplary schematic diagram illustrated in FIG. 26 and described in an automated tag generation process flow diagram 1650 presented in FIG. 27. A number of automated tag marking machines 1610 can be deployed at various locations throughout a territory. The article return system would be integrated with the automated tag marking machine 1610. Initially, the customer would purchase a customized tag 1630 (step 1660). The purchase can be completed at a sales counter, using an automated payment system that would be integrated into the automated tag marking machine 1610, and the like. Upon completion of the transaction, the automated tag marking machine 1610 would proceed in obtaining information to be scribed upon an article return identification tag 1630 as well as any personal information to provide an association between the article return identification tag 1630 and the user's return service provider account (step 1662). The information would be forwarded to a process controller subassembly 1612 integrated into the automated tag marking machine 1610. In a scenario where the user already has a return service provider account, the user would enter their return service provider account information into the automated tag marking machine 1610 using an alphanumeric keyboard 1614 and/or a numeric keyboard 1616. The process controller subassembly 1612 would communicate with the article return service company server 792 via a machine process controller and return service provider server communication link 1619. The article return service company 790 can generate a unique tag registration identifier (step 1666) and convey the tag registration identifier to the process controller subassembly 1612 via the point of sale and return service provider server communication link 1519. In a scenario where the user does not have a return service provider account, the user would enter their personnel information into the automated tag marking machine 1610. The process controller subassembly 1612 would then forward the user's personnel information to the article return service company server 792 (step 1664). The article return service company server 792 would create a new account associated with the user. The article return service company server 792 would then generate a unique tag registration identifier (step 1666) and convey the tag registration identifier to the process controller subassembly 1612 via the point of sale and return service provider server communication link 1519.

The user would enter any tag specific information, such as pet name 1638, owner address, owner telephone number, and the like (step 1668). The automated tag marking machine 1610 could provide an image of the proposed designed layout to the user for verification. The user would be able to make any changes until the proposed designed layout is approved. Once approved, the automated tag marking machine 1610 would proceed with scribing the proposed designed layout into the article return identification tag 1630 (step 1669). The scribing process can be accomplished using any suitable process capable of scribing the material selected for the article return identification tag 1630, including mechanically etching, machining, laser etching, water jet etching, chemically etching, and the like. The exemplary illustration presents a machine engraving process using tag marking system 1620. The exemplary tag marking system 1620 includes a tag marking head 1624 supported by a tag marking system gantry 1622. The tag marking system gantry 1622 can control a position of the tag marking head 1624 along an left to right (lateral) direction, a front to back (depth) direction and an up and down (vertical or height) direction. The article return identification tag 1630 would be supported by a tag support platform 1626. Upon completion of the etching process, the article return identification tag 1630 would be dispensed through a tag dispenser 1628 of the automated tag marking machine 1610. The user would collect the article return identification tag 1630 from the tag dispenser 1628.

The user would then secure the article return identification tag 1630 to the desired object (step 1670). Objects can include a pet by way of a pet collar, luggage, a key chain, and the like.

At times, the customer may accidentally leave the object carrying the article return identification tag 1630 behind. A finding party locates the misplaced or accidentally forgotten object carrying the article return identification tag 1630 (step 1672). The finding party would use the portable computing device 400 to obtain the tag identifier from the article return identification tag 1630 (step 1674). The article return identification tag 1630 preferably includes application access information 1636, which would direct an individual that finds the object to the application or website associated with the article return service company 790.

This can be accomplished by scanning a machine readable version of the human readable article registration identifier 1634 (not shown), manually entering the human readable article registration identifier 1634, using optical character recognition (OCR) to acquire the human readable article registration identifier 1634, and the like. The portable computing device 400 would automatically obtain the location where the article return identification tag 1630 is scanned or entered and forward the information to the article return service company 790 by way of a machine process controller and return service provider server communication link 1619.

The service provider would complete the steps for notifying the rightful owner of the article to return the accidentally forgotten object carrying the article return identification tag 1630 accordingly (step 1676). The steps would be similar to those presented in the article return process flow diagram 1300. The located article is returned to the rightful owner (step 1680).

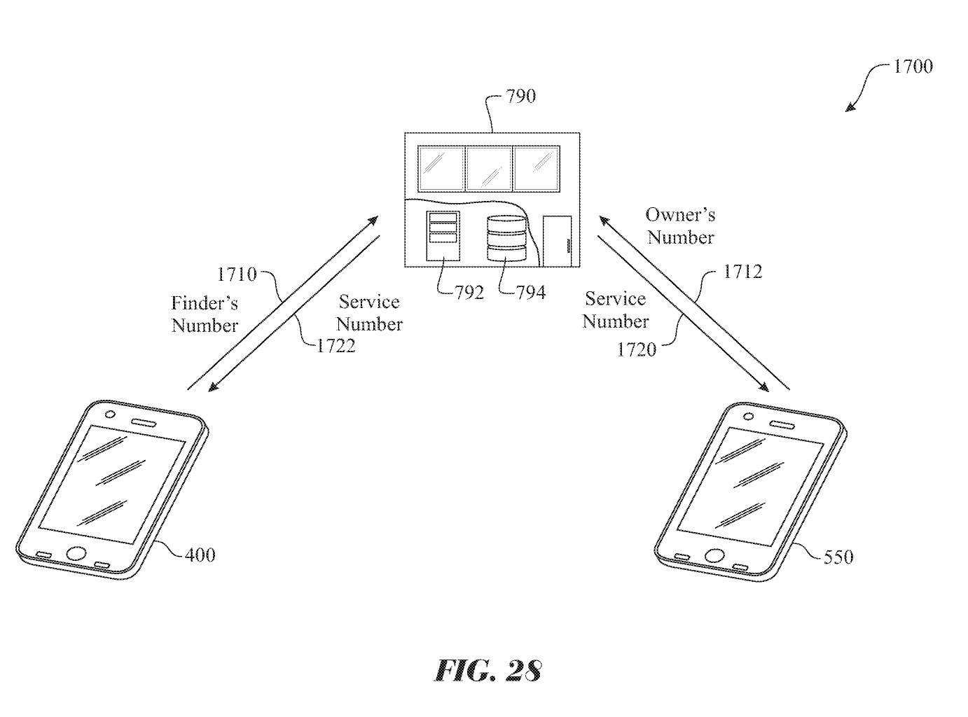

The overall article return process provides a service for notifying a rightful owner of a location of an item using an anonymous system. The system can provide a communication link between the rightful owner and the individual/merchant that finds the forgotten item, as illustrated in the exemplary schematic diagram referred to as an anonymous communication schematic diagram 1700, as illustrated in FIG. 28. The article return service company server 792 can act as an intermediary communication center. The finding party, represented by the portable computing device 400, transmits information to the article return service company server 792 by way of a finder's inbound communication step 1710. The upload includes the associated telephone number or other electronic identifier associated with the portable computing device 400. The message is then processed and forwarded to the rightful owner, represented by the card owner's cellular telephone 550, by way of an owner's inbound communication step 1720. The download message references the service provider's contact information, not the associated telephone number or other electronic identifier associated with the portable computing device 400. Similarly, the card owner's cellular telephone 550 transmits information to the article return service company server 792 by way of an outbound communication to finder step 1712. The upload includes the associated telephone number or other electronic identifier associated with the card owner's cellular telephone 550. The message is then processed and forwarded to the finding party, represented by the portable computing device 400, by way of an outbound communication to owner step 1722. The download message references the service provider's contact information, not the associated telephone number or other electronic identifier associated with the card owner's cellular telephone 550. This process retains anonymity between parties, while providing two way communication. This is accomplished by retaining the telephone number or other electronic identifier associated with each of the portable computing device 400 and the card owner's cellular telephone 550 throughout the corresponding time period. Each telephone number or other electronic identifier associated with the portable computing device 400 and the card owner's cellular telephone 550 could be associated with a specific identifier to ensure that the two parties are able to communicate with one another regarding one specific item. The article return service company server 792 can store the associated information for extended periods of time or until one of the two parties' requests that the information be removed.

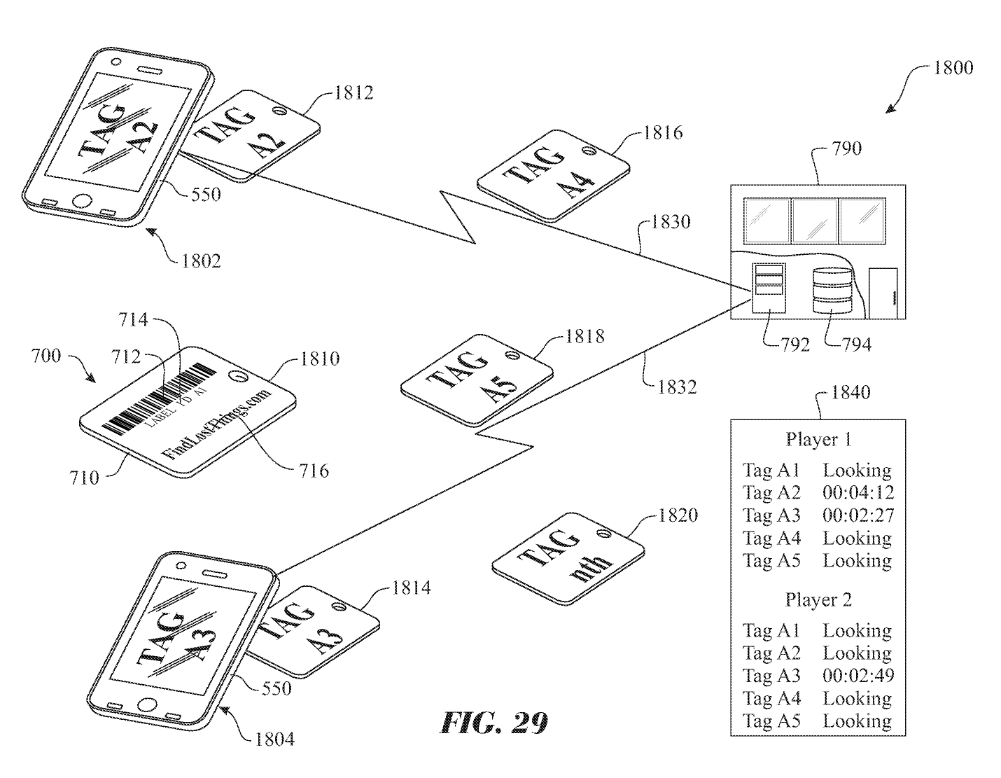

The article return process can be adapted to a scavenger hunt game 1800, as illustrated in FIG. 29. The game would be arranged by hiding a number of objects, each object would carry an associated tag or identifier in any suitable format. The exemplary illustration includes a series of six (6) tags 710 (referenced as 1810, 1812, 1814, 1816, 1818, 1820), wherein one tag 710 would be secured to each of the hidden objects. Each of the tags 710 would have a unique machine readable article registration identifier 712 and/or human readable article registration identifier 714. The user would follow clues to locate each of the tags 710. As each tag 710 is found, the player would scan the machine readable article registration identifier 712 and/or the human readable article registration identifier 714. In the exemplary embodiment, a first player 1802 is reading the machine readable article registration identifier 712 (as shown in the scavenger hunt first tag 1810) of the scavenger hunt second tag 1812 using their card owner's cellular telephone 550. Additionally, a second player 1804 is reading the machine readable article registration identifier 712 (as shown in the scavenger hunt first tag 1810) of the scavenger hunt third tag 1814 using their card owner's cellular telephone 550. The system would acquire the identifier of the respective tag 710, determine the location of the respective tag 710 and forward the identifier and location to the article return service company server 792. The article return service company server 792 would then determine which player 1802, 1804 provided which data and process the information accordingly, as shown in the scavenger hunt score keeping ledger 1840.

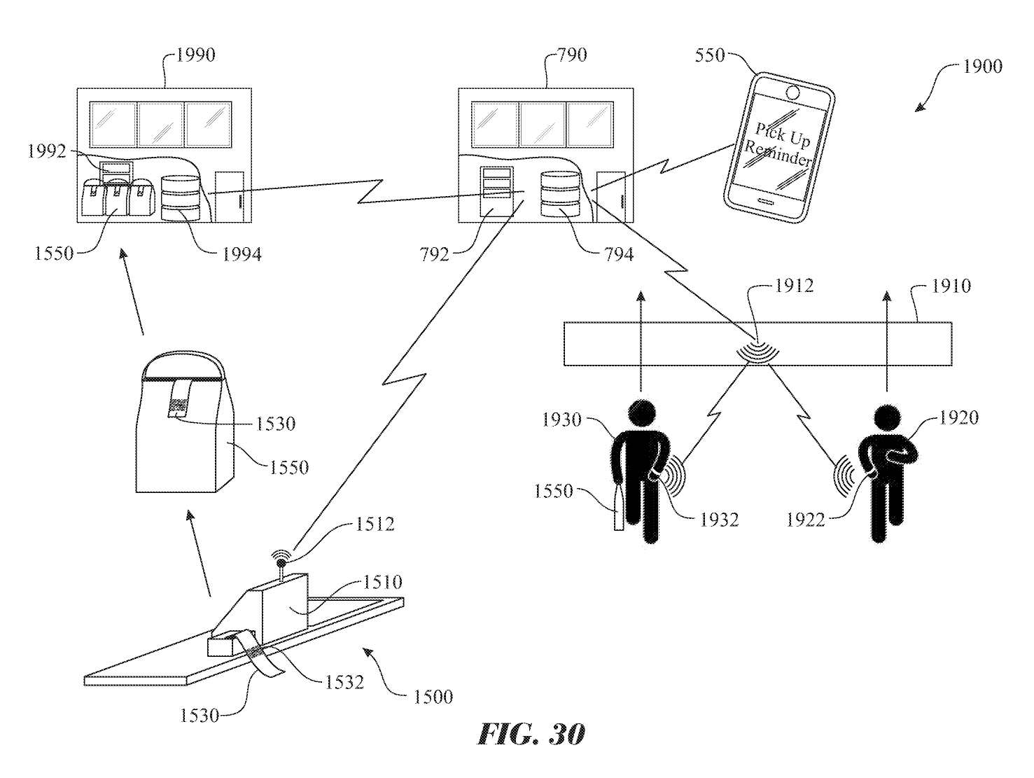

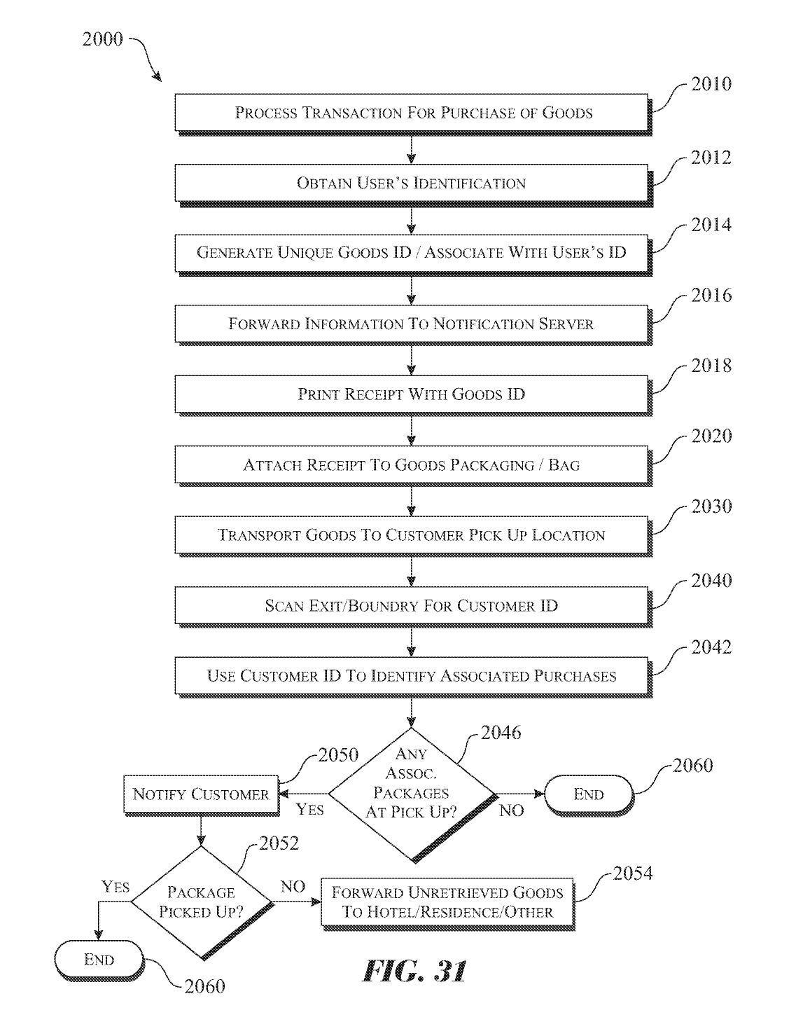

The return process can be modified to be adapted to operate as a package pick up reminder system 1900, as illustrated in FIG. 30; with an operational process being detailed in a package pick up reminder flow diagram 2000 illustrated in FIG. 31. The package pick up reminder system 1900 utilizes an association between an identifier, such as the machine readable purchase registration identifier 1532 printed on the transaction receipt 1530 and the user's account.

The process initiates with a user creating an account with the article return/pickup reminder service company 790. Preferably, the user would carry a personal identifier, such as a wireless identifier, such as a wireless customer identifier 1922, 1932. It is understood that the process for identifying the individual and the individual's associated account can be provided in forms alternative to the wireless customer identifier 1922, 1932, such as a magnetic strip provided upon a plastic, paper, metal, or other card; use of a biometric reader; use of facial recognition or other visual recognition processes, and the like. The personal identifier would be associated with the individual's account with the article return/pickup reminder service company 790. Once this association is established, the individual can utilize the process for any number of functions, such as those described above, to obtain reminders for picking up articles, packages, and the like, or any other function adaptable to the article return and/or reminder process.

In the exemplary embodiment, the customer or individual 1920, 1930 would select one or more items for purchase from a merchant. The customer or individual 1920, 1930 would initiate a transaction for purchasing the selected one or more items (step 2010). The transaction can be accomplished using a cashier at a goods transaction completion station 1500, a self-checkout process at a self-checkout station, a roaming payment processing associate, and the like. At some point during the transaction process, the customer or individual 1920, 1930 would provide their personal identifier to the point of sale (POS) system 1510, or more specifically, obtain the user's identification associated with the pickup reminder system (step 2012). Additionally, at some point during the transaction process, the point of sale (POS) system 1510 generates or obtains a unique goods identity to associate the purchased items with the customer or individual 1920, 1930 through an association with the individual's account (step 2014). The point of sale (POS) system 1510 would communicate with the article return/pickup reminder service company server 792 of the article return/pickup reminder service company 790 to ensure the goods identity is unique. In one variant, the goods identity can be or include the individual's personal identifier. In another variant, the account associated with the individual can include a series of predefined article identifiers. In yet another variant, the article return/pickup reminder service company server 792 can issue an article identifier for the purchase, wherein the issued article identifier would be associated with the individual's account by the article return/pickup reminder service company server 792. In a condition where the goods identity is not yet associated with the individual's account, the goods identity can be provided to the article return/pickup reminder service company server 792 from the point of sale (POS) system 1510, either during or shortly following the transaction process (step 2016). The point of sale (POS) system 1510 would forward the goods identity to the article return/pickup reminder service company 790 for association with the individual's account.

The point of sale (POS) system 1510 would complete the purchase transaction by printing a transaction receipt 1530. The point of sale (POS) system 1510 would include a machine readable purchase registration identifier 1532 on the transaction receipt 1530 (step 2018). The machine readable purchase registration identifier 1532 would be provided in any machine readable format, such as a Quick Read (QR) code, a barcode, or any other suitable format as well as human readable format. The receipt 1530 would be secured to an exterior of the shopping bag/package 1550 or inserted into the shopping bag/package 1550 for use should the shopping bag/package 1550 become misplaced, forgotten, and the like (step 2020). Alternatively, in the exemplary process, the sales clerk would secure the transaction receipt 1530 to the shopping bag/package 1550 and process the shopping bag/package 1550 to be forwarded to a package pick up location 1990 for pickup later in the day by the customer or individual 1920, 1930. The shopping bag/package 1550 is collected, along with any other shopping bags/packages 1550 and transported to the package pick up location 1990 (step 2030). The article identifier can forwarded to a package pick up location server 1992 at the package pick up location 1990 from the point of sale (POS) system 1510 prior to, during, or following the process of transporting the shopping bag/package 1550 to the package pick up location 1990. This can ensure that the shopping bag/package 1550 is received at the package pick up location 1990. Upon arrival, the machine readable purchase registration identifier 1532 on the transaction receipt 1530 can be scanned by a service person, an automated system, or any other process employed or implemented at the package pick up location 1990. The information associated with each shopping bag/package 1550 would be stored on a package pick up location database storage device 1994, wherein the package pick up location database storage device 1994 is in signal communication with the package pick up location server 1992. The package pick up location 1990, through the package pick up location server 1992 would convey each article identifier to the article return/pickup reminder service company server 792. The article return/pickup reminder service company server 792 would associate each article identifier of each shopping bag/package 1550 with the proper account. Additionally, the article return/pickup reminder service company server 792 would record a current location of the shopping bag/package 1550, wherein the article return/pickup reminder service company server 792 would indicate that the respective shopping bag/package 1550 is currently residing at the package pick up location 1990. These series of records configure the package pick up reminder system 1900 to enable operation of the package pickup reminder system.

When a shopping bag/package 1550 is picked up at the package pick up location 1990, the service person could obtain the individual's identifier. This provides several benefits. A first benefit would be the recording that the specific shopping bag/package 1550 is being collected from the package pick up location 1990. The package pick up location server 1992 would toggle the status of the shopping bag/package 1550 from pending inventory to be picked up/delivered. The package pick up location server 1992 can convey the status change to the article return/pickup reminder service company server 792 for recordation on the article return/pickup reminder service company database storage device 794 accordingly. A second benefit validates proper ownership of the shopping bag/package 1550. By knowing both the package identifier and the personal identifier, the package pick up location server 1992 can validate proper ownership of the shopping bag/package 1550. This ensures the shopping bag/package 1550 is being picked up by or delivered to the proper owner.

The package pick up reminder system 1900 includes one or more customer scanning locations 1910 located at predetermined key locations in a region. Regions can include a theme park, a zoo, an arena or stadium, a shopping mall, a flea market, a cruise ship, a resort, a port of call, an island, a festival, a carnival, and the like. In one example, the customer scanning location 1910 and preferably the package pick up location 1990 would be located near an exit from the theme park. In another example, the customer scanning location 1910 and preferably the package pick up location 1990 would be located near an exit of the arena or stadium. In yet another example, the customer scanning location 1910 and preferably the package pick up location 1990 would be located near a boarding location/disembarking location of a cruise ship.

A customer scanner 1912 would be located at the customer scanning location 1910. The customer scanner 1912 would monitor the region around the customer scanning location 1910 for customers or individuals 1920, 1930 passing by or through the customer scanning location 1910 (step 2040). The customer scanner 1912 would receive an identity of each customer or individual 1920, 1930 passing by or through the customer scanning location 1910 from a wireless customer identifier 1922, 1932. The exemplary wireless customer identifier 1922, 1932 is provided in a form of an RFID bracelet. It is understood that the wireless customer identifier 1922, 1932 can be provided in any form factor comprising any suitable wireless transceiver, such as a card; a label, sticker or appliqué; a button, a pin, a block, and the like. In an alternative solution, the wireless customer identifier 1922, 1932 can be of any other device capable of conveying information. For example, the wireless customer identifier 1922, 1932 can be a magnetic strip applied to a card or similar supporting structure. In another example, the wireless customer identifier 1922, 1932 can be provided by a beacon emission from a Smartphone. The beacon emission or signal could be transmitted on a Bluetooth system of the Smartphone, a Wi-Fi system of the Smartphone, or any other adapted protocol. In yet another example, the customer scanner 1912 can be configured to acquire one or more biometric identifiers, such as a fingerprint, facial recognition, iris recognition, and the like. The system can be a contact system or a contactless system, based upon the established form of the one or more identifiers determined by the system design team. In yet another example, the customer or individual 1920, 1930 can simply enter the associated identifier (as the customer scanner 1912 or replacing the customer scanner 1912) into an entry device located at the customer scanning location 1910.

Once the customer's identifier is acquired by the customer scanner 1912, the customer scanner 1912 transfers the customer's identifier to the article return/pickup reminder service company server 792 at the article return/pickup reminder service company 790 (or a similar operating unit at any suitable location). The article return/pickup reminder service company server 792 can search information stored on the article return/pickup reminder service company database storage device 794 to determine if the shopping bag/package 1550 associated with the specific customer or individual 1920, 1930 has been picked up from the package pick up location 1990. Alternatively, the article return/pickup reminder service company server 792 can communicate with the package pick up location 1990 using any suitable communication system and obtain a status of any and/or all shopping bags/packages 1550 that currently reside at the package pick up location 1990 that are associated with the specific customer or individual 1920, 1930. In a condition where any shopping bag/package 1550 associated with the specific customer or individual 1920, 1930 remains at the package pick up location 1990, the article return/pickup reminder service company server 792 would transmit a message to the specific customer or individual 1920, 1930 (step 2050). The notification can be accomplished using text messaging, email, voice message, a personal phone call, or any other suitable communication service as described above. In the exemplary illustration, the second exemplary customer 1930 has already picked up their shopping bag/package 1550, while the first exemplary customer 1920 still has at least one shopping bag/package 1550 remaining at the package pick up location 1990. In this case, the article return/pickup reminder service company server 792 would transmit a reminder message to the first exemplary customer 1920, while the second exemplary customer 1930 would continue without any need for a reminder.

The package pick up location server 1992 would periodically review the status of the stored shopping bags/packages 1550 to determine if the shopping bag/package 1550 is retrieved by the proper customer or individual 1920, 1930. If the shopping bag/package 1550 has been retrieved by the proper customer or individual 1930, the process for that shopping bag/package 1550 terminates (step 2060). If the shopping bag/package 1550 has not been retrieved by the proper customer or individual 1920 before a predetermined time, the process directs the associate/service person to further process the package (step 2054). This can include calling the respective customer or individual 1920, sending a message to the customer or individual 1920, forwarding the shopping bag/package 1550 to a hotel room where the customer or individual 1920 is understood to be staying at, the residence of the customer or individual 1920, or any other suitable location.

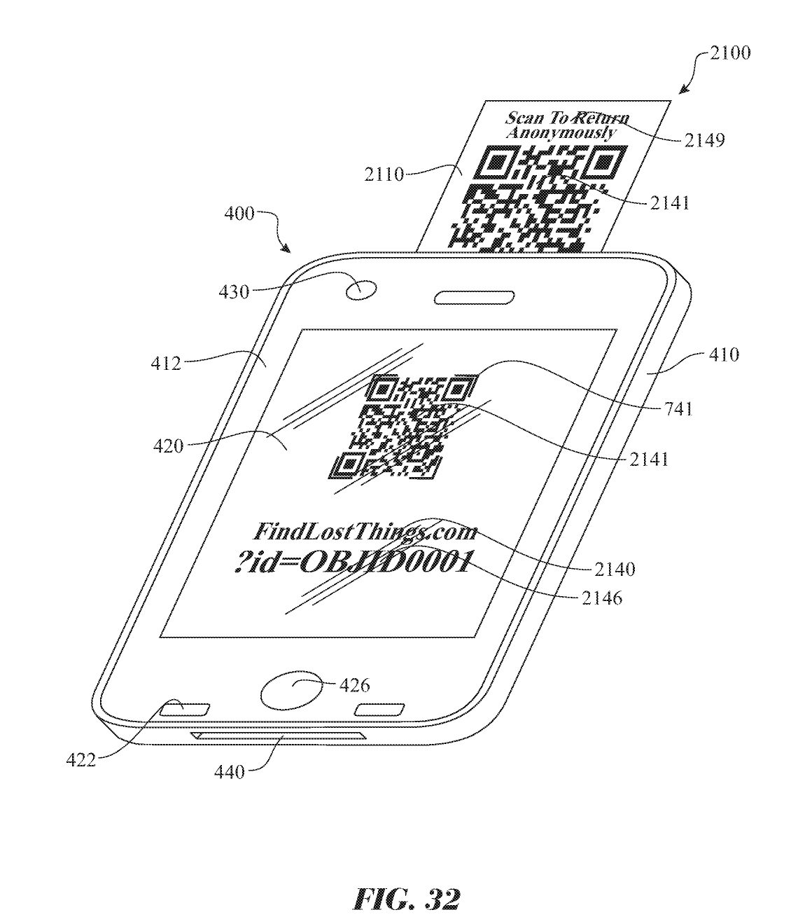

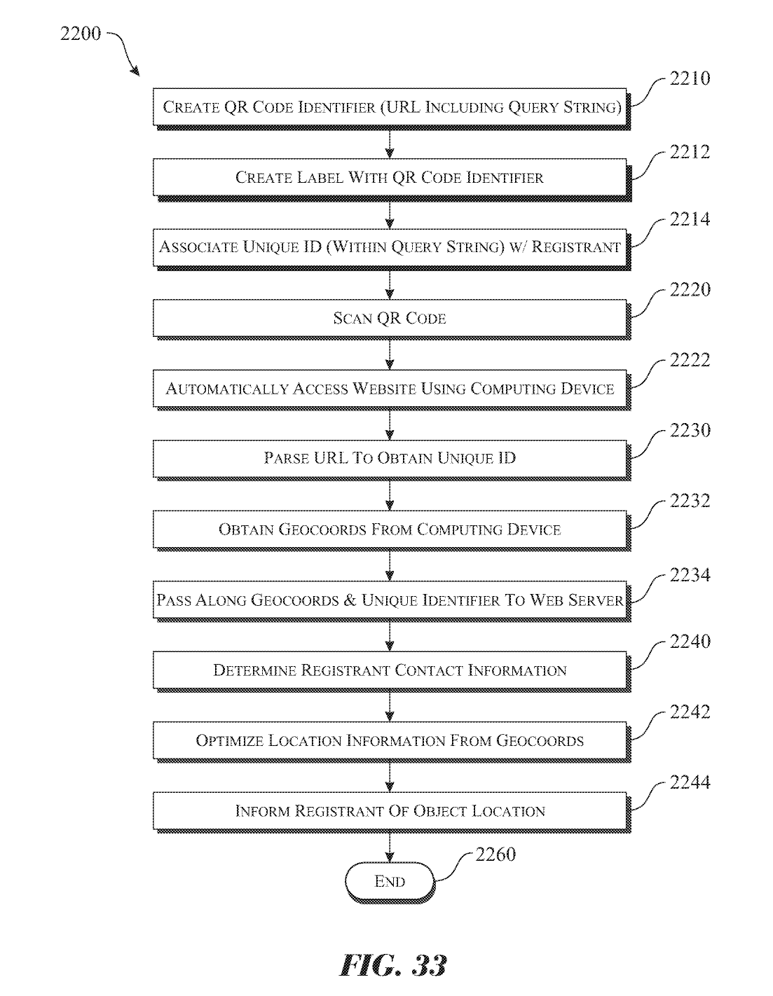

The above described methods can be enhanced by introducing a machine readable code, such as a Quick Read (QR) code article owner association tag 2100, as introduced in FIG. 32, where the Quick Read (QR) code article owner association tag 2100 initiates a link to a website (generally provided as a Universal Resource Locator (URL) identification reference 2140) and provides an article description unique identifier 2146. When an individual finds an article that appears to be misplaced by the owner and recognizes a Quick Read (QR) code article owner association tag 2100 carried by the object, a finding party instructions 2149 printed upon the Quick Read (QR) code article owner association tag 2100 instructs the individual who finds the article to scan the Quick Read (QR) code article owner association tag 2100 to return the article to the registrant anonymously. The individual who finds the article is not informed of the identity of the registrant and the registrant is not informed of the identity of the individual who finds the article. The system can optionally include features enabling the individual who finds the article to include additional information, which can include the identity or other pertinent information associated with the individual who finds the article if desired. Additionally, the system can provide a method for the two parties to communication with one another directly or indirectly. The bidirectional communication capabilities additionally enables inclusion of other features, such as a donation system, a reward system, and the like.

Details of the operation of the employment of the Quick Read (QR) code article owner association tag 2100 are described in a Quick Read (QR) code automated system flow diagram 2200 presented in FIG. 33. The process initiates with a step of creating a Quick Read (QR) code identifier (step 2210), wherein the Quick Read (QR) code identifier is a Universal Resource Locator (URL) that includes a query string. The query string includes an article unique identifier 2146. In the exemplary illustration, the Quick Read (QR) code identifier is http://FindLostThings.com?id=OBJID00001, essentially combining the Universal Resource Locator (URL) identification reference 2140 and the article unique identifier 2146. The process continues with a creation of a label or tag 1200 containing the Quick Read (QR) code 2141 (step 2212), as shown in FIG. 32. The Quick Read (QR) code article owner association tag 2100 is affixed to an article using any suitable attachment process, including adhesive (a sticker, adhesive, adhesive tape, and the like), an attachment loop (string, ribbon, a rubber band, a silicone loop, a plastic loop, a cable tie, and the like), mechanical fasteners (rivets, staple, and the like), use of a carrier (business card holder, luggage tag holder, and the like), a pin, or any other suitable coupling mechanism known to those skilled in the art and would be related to a method for attaching a tag substrate 2110 to an article. The registrant is associated with the unique identifier of the article unique identifier 2146 by any suitable process. The association is preferably recorded and indexed in a database operated by a service provider. Once the Quick Read (QR) code article owner association tag 2100 is associated with an article, the registrant can associate the article unique identifier 2146 with the respective article. Once the Quick Read (QR) code article owner association tag 2100 is affixed to the article, the process for recovering the article when misplaced or lost is available for use.

When an article carrying the Quick Read (QR) code article owner association tag 2100 is found by an individual, the individual is instructed to scan the Quick Read (QR) code article owner association tag 2100 using a Quick Read (QR) code scanner by a finding party instructions 2149. Any suitable Quick Read (QR) code scanner can be used. This process circumvents a requirement for downloading and installing an application, looking up and manually initiating access to a website, and the like. This process essentially enables a one step process accomplished by an operator for identifying a location of an article and informing the registered party where that the article was found and the location where the article was found.

The individual who finds the article would scan the Quick Read (QR) code article owner association tag 2100 using the Quick Read (QR) code scanner application operating on any Quick Read (QR) code scanner enabled computing device (step 2220). The Quick Read (QR) code scanner enabled computing device can include a portable computing device, a portable computing laptop, a portable computing tablet, a Smartphone, a Personal Data Assistant (PDA), Quick Read (QR) code enabled desktop computer, and the any other suitable Quick Read (QR) code scanner enabled computing device. The scanning step is essentially the only step required for execution of the process to inform the registrant of the location of the associated found article. It is recognized that the process may include additional steps. For example, certain portable electronic computing devices may request permission for use of the location acquisition feature of the device. In another example, the process may include a step of requesting that the operator confirm the location information acquired using the geolocating processes of the portable computing device. In yet another example, the process may include a step of offering to have the operator provide any additional information that might be useful to the rightful owner when pursuing retrieval of the associated article.

Once scanned, the information would be decoded and subsequently direct the computing device to access a website associated with the Universal Resource Locator (URL) 2140 decoded from the Quick Read (QR) code article owner association tag 2100 (step 2222). The local portable computing device would parse the Quick Read (QR) code identifier to obtain the article unique identifier 2146 (step 2230). The process would direct the computing device to provide geocoordinates (step 2232). The portable computing device would obtain the geocoordinates using any suitable location determining process, including employment of a Global Positioning System (GPS), an equivalent to the Global Positioning System (GPS) (such as GLObal NAvigation Satellite System (GLONASS)), beacon navigation, cellular triangulation, Wi-Fi location determining processes, and the like. The computing device would pass along the acquired geocoordinates to the web server (step 2234). Once the web server receives the information from the computing device, the web server can utilize the article unique identifier 2146 to determine the registrant associated with the article unique identifier 2146 and the contact information associated with the registrant (step 2240).

The web server can utilize the geocoordinates to obtain alternative descriptions of the location identified by the computing device (step 2242). For example, the geocoordinates can be used to identify a location on a respective map. The map can be at least one of a static map and a live map. The process can provide at least one of the static map and the live map to the registrant associated with the article unique identifier 2146. In another example, the geocoordinates can be used to determine an address based upon or closest to the geocoordinates. The static map would be a static image identifying the location of the computing device at the time when the scanning process was completed, the location being identified upon a regional map. The live map would identify the location of the computing device at the time when the scanning process was completed on an active map. The active map can additionally identify a location of the registrant respective to the location of the computing device at the time when the scanning process was completed. The live map can additional offer and provide directions between the registrant and the obtained geocoordinates of the location of the electronic device (representative of the location of the article). The use of the geocoordinates for identifying the location on the map would provide more accuracy compared to a location using an address that was determined from the acquired geocoordinates.

Once the web server has determine at least one suitable method for conveying the location of the computing device at the time when the scanning process was completed (which would be representative of the location of the found article), the web server would initiate a process of informing the registrant that the associated article was found and the location of the computing device at the time when the scanning process was completed (which would be representative of the location of the found article) (step 2244). The step of providing the location of the electronic device to the registrant of the QR code can be accomplished by any suitable communication process, including at least one of: transmitting an email, transmitting a message using Short Message Service (SMS), transmitting a message using Multimedia Messaging Service (MMS), transmitting an email, providing an audible telephone message, providing an automated telephone message, posting a message to an associated social media site, and the like.

Once the web server notifies the registrant that the article was found and the assumed current location thereof, the process can opt to terminate accordingly (step 2260).

It is understood that the process can include additional, optional features. For example, the process can include a method enabling the registrant to confirm receipt of the message informing them of the found article. The process can include a method enabling the registrant to communicate with the person who found the article, either anonymously, or directly.

In another aspect, the step of providing the location of the electronic device to the registrant of the QR code is accomplished by at least one of transmitting an email, transmitting a message using Short Message Service (SMS), transmitting a message using Multimedia Messaging Service (MMS), providing an audible telephone message, providing an automated telephone message, posting a message to an associated social media site, providing a push notification, and the like.

It is understood that the concept and service can be adapted to other applications and articles. One example would be RFID or near field communicating devices, such as bracelets, necklace tags, luggage tags, security tags, and the like. The information can be manually entered, optically character recognized, or conveyed using the near field communication from the RFID or near field communicating device to the portable computing device 400. This can be applied to pick up location, bracelets, theme park admission tickets or bands, pins, stickers, and the like. Theme parks, cruise ships, resorts or hotels, and the like can additionally offer printed labels having a unique registration number/identifier associated with their account upon arrival at the hotel and/or entry into the park, the cruise ship, the resort or hotel property, and the like. The visitor would secure or adhere the label to each bag or other desired article, thus enabling notification of a found item, should the visitor become separated from the article.

The same process can be applied to notifying a parent or guardian of a child's location when the child or other person (senior, disabled, mentally challenged) gets separated from the parent or guardian.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

### ELEMENT DESCRIPTION REFERENCES

| Ref. No. | Description |
|---|---|
| 100 | recovery card reporting process |
| 102 | patron leaves a financial card at a merchant or other location |
| | step |
| 104 | recovering party accesses the card recovery system step |
| 106 | recovery party enters the card information step |
| 108 | card information is recorded within a recovered card database |
| | step |
| 110 | recovery party additionally enters the location where the |
| | card resides step |
| 112 | card location is recorded within a recovered card database |
| | step |
| 150 | seeking party submission process |
| 152 | recognizing that a card has been misplaced or left at an |
| | unknown location step |
| 154 | card owner would access the card recovery system step |
| 156 | owner can provide owner information step |
| 158 | owner can optionally enter a most probable location where |
| | the owner believes they might have left the card step |
| 170 | card locating flow diagram |
| 172 | owner name and card name comparison step |
| 174 | returns a listing of all cards having a matching owner's |
| | name step |
| 176 | optional sort and/or reduce the returned listing of cards |
| | based upon a distance from the location step |
| 178 | initiate proper ownership verification/narrow the listing |
| | step |
| 180 | proper ownership identification decision step |
| 182 | provide the location of the recovered card to the owner step |
| 184 | owner presents some form of picture identification to the |
| | merchant step |
| 186 | optional merchant records the owner information step |
| 188 | conclusion step |
| 190 | transferring the card to the rightful owner step |
| 200 | clearinghouse confirmation process |
| 202 | uploads the card number to a financial clearing company |
| | step |
| 204 | information provided by the searching party is uploaded |
| | to the clearing company step |
| 206 | determine if the card information matches the provided |
| | owner information step |
| 208 | proper ownership determine decision step |
| 212 | proper ownership identified to the proper ownership has |
| | been identified step |
| 300 | financial card |
| 310 | financial card substrate |
| 312 | card primary information presenting surface |
| 320 | financial card issuing merchant information |
| 322 | financial card issuing merchant logo |
| 330 | financial card number |
| 332 | card owner first name |
| 334 | card owner last name |
| 336 | card expiration date |
| 340 | digital information storage medium |
| 400 | portable computing device |
| 410 | portable computing device housing |
| 412 | portable computing device viewing surface |
| 414 | portable computing device microprocessor |
| 416 | portable computing device digital memory |
| 418 | portable computing device location identification system |
| 420 | portable computing device display |
| 422 | microphone |
| 424 | speaker |
| 426 | tactile input interface |
| 429 | screen lock indicator |
| 430 | integrated camera |
| 440 | first connector |
| 442 | second connector |
| 450 | acquired digital image |
| 460 | card data reading device |
| 490 | notification monitor |
| 492 | notification monitor display |
| 494 | initial based notification |
| 495 | username based notification |
| 496 | flight and seat based notification |
| 500 | financial card recovery schematic flow diagram |
| 502 | locating computing device Internet communication link |
| 504 | locating computing device cellular communication link |
| 510 | Internet |
| 512 | Internet to card issuing company Internet communication |
| | link |
| 514 | Internet to card owner Internet communication link |
| 520 | cellular network |
| 522 | cellular network to Internet communication link |
| 524 | cellular network to card issuing company cellular communi- |
| | cation link |
| 526 | cellular network to card owner landline communication |
| | link |
| 528 | cellular network to card owner cellular communication |
| | link |
| 530 | card issuing company |
| 532 | card issuing company server |
| 534 | card issuing company database storage device |
| 538 | card issuing company to card owner landline communication |
| | link |
| 540 | card owner's residence/business |
| 542 | card owner's resident computing device |
| 550 | card owner's cellular telephone |
| 600 | financial card recovery flow diagram |
| 610 | card data acquisition step |
| 612 | acquire card location information step |
| 614 | determine card issuing company information step |
| 616 | optional encrypt data step |
| 618 | transmit card information and associated card location to |
| | card issuing company step |
| 620 | identify card owner contact information step |
| 622 | contact card owner step |
| 624 | provide card location information to card owner step |
| 626 | optional: provide security code to card owner & card holder |
| | step |
| 628 | card owner claims card step |
| 700 | article owner association tag |
| 710 | tag substrate |
| 711 | tag attachment aperture |
| 712 | machine readable article registration identifier |
| 714 | human readable article registration identifier |
| 716 | application access information |
| 717 | application access Quick Read (QR) code |
| 720 | article owner association tag image |
| 722 | machine readable article registration identifier image |
| 724 | human readable article registration identifier image |
| 726 | application access information image |
| 730 | numeric article identification reference |
| 740 | alphanumeric article identification reference |
| 741 | article identification Quick Read (QR) code |
| 742 | family reference index identifier |
| 744 | family member identifier |
| 746 | article description identifier |
| 750 | passive wireless transceiver |
| 752 | luggage owner notification |
| 760 | luggage identification system |
| 762 | active wireless transceiver |
| 772 | luggage identification system and Internet communication |
| | link |
| 774 | article return service provider and Internet communication |
| | link |
| 780 | luggage claim conveyor |
| 782 | luggage identification system and Cellular network communi- |
| | cation link |
| 784 | article return service provider and Cellular network communi- |
| | cation link |
| 788 | portable computing device and Cellular network communi- |
| | cation link |
| 790 | article return/pickup reminder service company |
| 792 | article return/pickup reminder service company server |
| 794 | article return/pickup reminder service company database |
| | storage device |
| 800 | key ring assembly |
| 810 | key |
| 820 | key ring |
| 850 | luggage |
| 860 | luggage container body |
| 862 | luggage handle |
| 864 | article owner association tag fastener |
| 870 | backpack |
| 880 | backpack body |
| 882 | backpack handle |
| 884 | article owner association tag fastener |
| 900 | umbrella |
| 910 | umbrella canopy |
| 920 | umbrella shaft |
| 922 | umbrella hand grip |
| 930 | hand grip located article owner association tag fastener |
| 932 | umbrella shaft located article owner association tag fastener |
| 940 | machine readable article registration identifier image |
| 942 | human readable article registration identifier image |
| 1000 | eyewear |
| 1010 | eyewear frame |
| 1012 | lens |
| 1020 | temple |
| 1030 | applied article owner association tag fastener |
| 1100 | footwear |
| 1120 | footwear sole |
| 1122 | footwear upper |
| 1124 | footwear laces |
| 1130 | applied article owner association tag fastener |
| 1200 | article return preparation process flow diagram |
| 1210 | owner registration with article return service provider step |
| 1221 | registrant name |
| 1222 | registrant address |
| 1223 | registrant cellular telephone number |
| 1224 | registrant email address |
| 1225 | registrant preferred contact method |
| 1226 | optional registrant photo |
| 1230 | assign unique article identifier to registrant step |
| 1232 | fabricate encoded article identifier(s) step |
| 1234 | provide fabricated article identifier(s) to registrant step |
| 1236 | attach article identifier(s) to article(s) |
| 1300 | article return process flow diagram |
| 1310 | activate application step |
| 1312 | determining user's current location step |
| 1313 | optionally acquire digital image of found article |
| 1314 | acquire image of article identifier step |
| 1316 | transmit article identifier and location information to article |
| | return service provider step |
| 1318 | determine registered party contact information associated |
| | with the article identifier step |
| 1320 | notify registered party of found article and reported article |
| | location step |
| 1322 | optional step of providing a security code to rightful article |
| | owner and article holder |
| 1324 | rightful owner returns to reported article location to collect |
| | article step |
| 1326 | optional step of validating security code to article holder |
| 1328 | collect lost/forgotten article step |
| 1400 | article return and incentive process flow diagram |
| 1410 | activate application step |
| 1412 | transmit article identifier and location information to article |
| | return service provider step |
| 1414 | identify article locating party from transmission step |
| 1416 | offer reward to article locating party step |
| 1418 | determine registered party contact information associated |
| | with the article identifier step |
| 1420 | notify registered party of found article and reported article |
| | location step |
| 1422 | registered party acknowledges receipt of notification |
| 1424 | offer incentive to rightful article owner step |
| 1500 | goods transaction completion station |
| 1510 | point of sale (POS) system |
| 1512 | point of sale (POS) communication subsystem |
| 1519 | point of sale and return service provider server communication |
| | link |
| 1520 | point of sale (POS) printer |
| 1530 | transaction receipt |
| 1532 | machine readable purchase registration identifier |
| 1534 | machine readable purchase registration identifier image |
| 1539 | finder's portable computing device and return service |
| | provider server communication link |
| 1540 | transaction station countertop |
| 1550 | shopping bag/package |
| 1552 | shopping bag handle |
| 1560 | goods purchase owner association process flow diagram |
| 1570 | select merchandise for purchase step |
| 1572 | obtain individual's return service company account |
| | identification information step |
| 1574 | enter/scan selected goods information into the point of sale |
| | (POS) system step |
| 1576 | complete sales transaction using the point of sale (POS) |
| | system step |
| 1578 | print receipt including article return service identifier step |
| 1579 | secure receipt onto shopping bag step |
| 1580 | locate misplaced/forgotten shopping bag step |
| 1582 | complete article return process procedure |
| 1584 | optional step of validating security code to article holder |
| 1590 | collect lost/forgotten article step |
| 1600 | tag customization system |
| 1610 | automated tag marking machine |
| 1612 | process controller subassembly |
| 1614 | alphanumeric keyboard |
| 1616 | numeric keyboard |
| 1619 | machine process controller and return service provider |
| | server communication link |
| 1620 | tag marking system |
| 1622 | tag marking system gantry |
| 1624 | tag marking head |
| 1626 | tag support platform |
| 1628 | tag dispenser |
| 1630 | article return identification tag |
| 1634 | human readable article registration identifier |
| 1636 | application access information |
| 1638 | pet name |
| 1650 | automated tag generation process flow diagram |
| 1660 | purchase identification tag step |
| 1662 | enter personal information step |
| 1664 | upload personal information to article return service provider |
| | server step |
| 1666 | assign unique article identifier step |
| 1668 | enter desired tag customization information step |
| 1669 | scribe information onto tag blank step |
| 1670 | secure the scribed tag onto an associated object step |
| 1672 | complete article return process procedure |
| 1674 | enter the article registration identifier (scan, OCR, manually |
| | enter) into the application step |
| 1676 | optional step of validating security code to article holder |
| 1680 | collect lost/forgotten article step |
| 1700 | anonymous communication schematic diagram |
| 1710 | finders inbound communication step |
| 1712 | outbound communication to finder step |
| 1720 | owners inbound communication step |
| 1722 | outbound communication to owner step |
| 1800 | scavenger hunt game |
| 1802 | first player |
| 1804 | second player |
| 1810 | scavenger hunt first tag |
| 1812 | scavenger hunt second tag |
| 1814 | scavenger hunt third tag |
| 1816 | scavenger hunt fourth tag |
| 1818 | scavenger hunt fifth tag |
| 1820 | scavenger hunt nth tag |
| 1830 | first scanned communication |
| 1832 | second scanned communication |
| 1840 | scavenger hunt score keeping ledger |
| 1900 | package pick up reminder system |
| 1910 | customer scanning location |
| 1912 | customer scanner |
| 1920 | first exemplary customer |
| 1922 | first exemplary customer wireless identifier |
| 1930 | second exemplary customer |
| 1932 | second exemplary customer wireless identifier |
| 1990 | package pick up location |
| 1992 | package pick up location server |
| 1994 | package pick up location database storage device |
| 2000 | package pick up reminder flow diagram |
| 2010 | process transaction for purchase of goods step |
| 2012 | obtain user's identification associated with the pickup |
| | reminder system step |
| 2014 | generate unique package identifier and associate package |
| | identifier with user's account step |
| 2016 | forward package identifier and association of user's account |
| | to package reminder system server step |
| 2018 | print receipt including package identifier in machine readable |
| | image and human readable image step |
| 2020 | secure receipt to package step |
| 2030 | transport package to the package pick up location step |
| 2040 | monitor or scan an area or boundary for passing customers |
| | to obtain customer identification step |
| 2042 | use customer's identification to identify associated packages |
| | step |
| 2044 | determine if any associated packages remain at the package |
| | pick up location decision step |
| 2050 | notify customer with a reminder to pick up package(s) at |
| | the package pick up location step |
| 2052 | package retrieved/remaining at package pick up location |
| | decision step |
| 2054 | forward unretrieved packages to hotel/residence/other step |
| 2060 | package pick up termination step |
| 2100 | Quick Read (QR) code article owner association tag |
| 2110 | tag substrate |
| 2140 | Universal Resource Locator (URL) identification reference |
| 2141 | article identification Quick Read (QR) code |
| 2146 | article unique identifier |
| 2149 | finding party instructions |
| 2200 | Quick Read (QR) code automated system flow diagram |
| 2210 | Quick Read (QR) code identifier generation step |
| 2212 | create label with Quick Read (QR) code based upon QR code |
| | identifier step |
| 2214 | associate article unique identifier with registrant step |
| 2220 | scan Quick Read (QR) code step |
| 2222 | automatically access website using an electronic computing |
| | device using the Universal Resource Locator (URL) from |
| | the Quick Read (QR) code step |
| 2230 | parse Universal Resource Locator (URL) to obtain article |
| | unique identifier step |
| 2232 | obtain geocoordinates from electronic computing device |
| 2234 | pass along geocoordinates and article unique identifier to |
| | web server step |
| 2240 | determine registrant and registrants contact information from |
| | article unique identifier step |
| 2242 | optimize location information from geocoordinates step |
| 2244 | inform registrant of article location step |
| 2260 | automated article location informing process termination step |

What is claimed is:

1. A method for informing a registrant of a current location of a misplaced newly purchased article, the method comprising steps of:
establishing a plurality of registrant's accounts on an article recovery service provider server, wherein each registrant's account of the plurality of registrant's accounts is associated with a registrant;
obtaining contact information for contacting each registrant;
recording the contact information for contacting each registrant on the article recovery service provider server, wherein the contact information is associated with the respective registrant's account;
assigning a package identifier to a package, wherein each package identifier is uniquely identified for association with the associated registrant from all other registrants of the article recovery service provider;
recording each package identifier in a manner associating each package identifier with the associated registrant's account on the article recovery service provider server, wherein the package identifier is associated with the respective registrant's account;
carrying the package identifier by the package;
scanning the machine readable code to acquire the package identifier when the package is misplaced;
determining the identity of the registrant associated with the package identifier;
determining contact information associated with the registrant associated with the package identifier;
transmitting a message to the registrant associated with the acquired package identifier, wherein the message informs the registrant of the location of the misplaced package.

2. A method for informing a registrant of a current location of a misplaced article of personal property as recited in claim 1, further comprising steps of:
providing the package identifier upon a receipt printed during a transaction process for purchase of the contents of the package, wherein the package identifier includes the machine readable code;
carrying the receipt by the package.

3. A method for informing a registrant of a current location of a misplaced article of personal property as recited in claim 1, further comprising steps of:
providing the package identifier as one of (a) the machine readable code preprinted upon a package identifier substrate or (b) the machine readable code printed upon the package identifier substrate during a transaction process for purchase of the contents of the package; and
carrying the package identifier substrate by the package.

4. A method for informing a registrant of a current location of a misplaced article of personal property as recited in claim 1, wherein the step of providing the package identifier upon a receipt applies the package identifier in a format selected from a group of package identifier formats comprising:
a numeric barcode,
an alpha-numeric barcode,
a Quick Read (QR) code, and
a Quick Read (QR) code comprising a Universal Resource Locator (URL), the Universal Resource Locator (URL) including an address for accessing a website associated with an article return process and a query string, the query string including the package identifier.

5. A method for informing a registrant of a current location of a misplaced article of personal property as recited in claim 1, wherein the step of providing the package identifier upon a receipt applies the package identifier in a format selected from a group of package identifier formats comprising a Quick Read (QR) code comprising a Universal Resource Locator (URL), the Universal Resource Locator (URL) including an address for accessing a website associated with an article return process and a query string, the query string including the package identifier,
further comprising steps of:
reading the QR code using an electronic computing device;
decoding the QR code comprising the Universal Resource Locator (URL);
accessing a website identified by the Universal Resource Locator (URL) obtained from the decoded QR code;
parsing the Universal Resource Locator (URL) to obtain the unique object identifier;
obtain the geocoordinates of a location of the electronic device using geolocation coding of the electronic computing device;
passing the parsed unique object identifier obtained from the decoded QR code and the obtained geocoordinates of the location of the electronic device to a web server associated with the Universal Resource Locator (URL);
determining contact information associated with a registrant of the QR code; and
providing the location of the electronic device to the registrant of the QR code.

6. A method for informing a registrant of a current location of a misplaced article of personal property as recited in claim 1, further comprising steps of
providing the package identifier as the machine readable code printed upon a quantity of package identifier substrates, the quantity of package identifier substrates creating at least one package identifier substrate for each package, the process of providing the package identifier as the machine readable code printed upon a quantity of package identifier substrates being completed during a transaction process for purchase of the contents of the package; and
carrying at least one package identifier substrate by each package.

7. A method for informing a registrant of a current location of a misplaced article of personal property as recited in claim 1, wherein the step of transmitting a message to the registrant associated with the acquired package identifier, wherein the message informs the registrant of the location of the misplaced package is accomplished by a least one of:
transmitting an email,
transmitting a message using Short Message Service (SMS),
transmitting a message using Multimedia Messaging Service (MMS),
providing an audible telephone message,
providing an automated telephone message,
posting a message to an associated social media site, and
providing a push notification.

8. A method for informing a registrant of a current location of a misplaced article of personal property, the method comprising steps of:
establishing a plurality of registrant's accounts on an article recovery service provider server, wherein each registrant's account of the plurality of registrant's accounts is associated with a registrant;
obtaining contact information for contacting each registrant;
recording the contact information for contacting each registrant on the article recovery service provider server, wherein the contact information is associated with the respective registrant's account;
assigning an article identifier to an article of personal property, wherein each article identifier is uniquely identified for association with the associated registrant from all other registrants of the article recovery service provider;
recording each article identifier in a manner associating each article identifier with the associated registrant's account on the article recovery service provider server, wherein the article identifier is associated with the respective registrant's account;
carrying the article identifier on the article of personal property, wherein the article identifier includes a machine readable code comprising a Universal Resource Locator (URL), the Universal Resource Locator (URL) including an address for accessing a website associated with an article return process and a query string, the query string including the package identifier;
reading the machine readable code using an electronic computing device;
decoding the machine readable code comprising the Universal Resource Locator (URL);
accessing a website identified by the Universal Resource Locator (URL) obtained from the decoded machine readable code;
parsing the Universal Resource Locator (URL) to obtain the unique object identifier;
obtain the geocoordinates of a location of the electronic device using geolocation coding of the electronic computing device;
passing the parsed unique object identifier obtained from the decoded machine readable code and the obtained geocoordinates of the location of the electronic device to a web server associated with the Universal Resource Locator (URL);
determining contact information associated with a registrant of the machine readable code; and
providing the location of the electronic device to the registrant of the machine readable code.

9. A method for informing a registrant of a current location of a misplaced article of personal property as recited in claim 7, wherein the machine readable code is provided in a format of one of:
an alpha-numeric barcode, and
a Quick Read (QR code).

10. A method for informing a registrant of a current location of a misplaced article of personal property as recited in claim 8, wherein the article of personal property is newly purchased and placed into a package, the method further comprising a step of:
applying the machine readable code upon a receipt, wherein the receipt is printed during a transaction process for purchase of contents of a package;
carrying the receipt by the package.

11. A method for informing a registrant of a current location of a misplaced article of personal property as recited in claim 8, wherein the article of personal property is newly purchased and placed into a package, the method further comprising steps of:
providing the machine readable code as one of (a) the machine readable code preprinted upon an article identification substrate or (b) the machine readable code printed upon the article identification substrate during a transaction process for purchase of the contents of the package; and
carrying the article identification substrate by the package.

12. A method for informing a registrant of a current location of a misplaced article of personal property as recited in claim 8, wherein the step of transmitting a message to the registrant associated with the acquired package identifier, wherein the message informs the registrant of the location of the misplaced package is accomplished by a least one of:
transmitting an email,
transmitting a message using Short Message Service (SMS),
transmitting a message using Multimedia Messaging Service (MMS),
providing an audible telephone message,
providing an automated telephone message,
posting a message to an associated social media site, and
providing a push notification.

13. A method for informing a registrant of a current location of a forgotten recent purchase, the method comprising steps of:
establishing a plurality of registrant's accounts on an article reminder service provider server, wherein each registrant's account of the plurality of registrant's accounts is associated with a registrant;
assigning a package identifier to a package, wherein each package identifier is uniquely identified for association with the associated registrant from all other registrants of the article reminder service provider;
recording each package identifier in a manner associating each package identifier with the associated registrant's account;
applying the package identifier to the package;
transferring the package to a package pick up location;
acquiring a personal identifier of registrants as each registrant passes by a personal identifier monitoring station;
using the acquired personal identifier to determine all package identifiers associate with the acquired personal identifier;
determining if any packages having package identifiers associated with the acquired personal identifier currently reside at the package pick up location; and
in a condition where at least one package having the package identifier associated with the acquired personal identifier currently resides at the package pickup center, transmitting a message to the registrant associated with the acquired personal identifier, wherein the message reminds the registrant to pickup at least one package that is currently residing at the package pickup center.

14. A method for informing a registrant of a current location of a forgotten recent purchase as recited in claim 13, wherein the step of acquiring a personal identifier of registrants as each registrant passes by a personal identifier monitoring station is accomplished using a Radio Frequency IDentification (RFID) circuit carried by the registrant.

15. A method for informing a registrant of a current location of a forgotten recent purchase as recited in claim 13, wherein the package identifier is an identification printed upon a receipt during the recent purchase.

16. A method for informing a registrant of a current location of a forgotten recent purchase as recited in claim 1, wherein the package identifier is an identification printed upon a receipt during the recent purchase, wherein the identification is printed in a machine readable format.

17. A method for informing a registrant of a current location of a forgotten recent purchase as recited in claim 13, the method further comprising steps of:
assigning a personal property identifier to an article of personal property, wherein each package identifier is uniquely identified for association with the associated registrant from all other registrants of the article reminder service provider;
recording each personal property identifier in a manner associating each article of personal property with the associated registrant's account;
applying the personal property identifier to the article of personal property.

18. A method for informing a registrant of a current location of a forgotten recent purchase as recited in claim 13, the method further comprising steps of:
assigning a personal property identifier to an article of personal property, wherein each package identifier is uniquely identified for association with the associated registrant from all other registrants of the article reminder service provider;
recording each personal property identifier in a manner associating each article of personal property with the associated registrant's account;
applying the personal property identifier to the article of personal property, wherein the personal property identifier includes a machine readable code;
scanning the machine readable code to acquire the personal property identifier;
determining the identity of the registrant associated with the personal property identifier;
determining contact information associated with the registrant;
transmitting a message to the registrant associated with the acquired personal identifier, wherein the message informs the registrant of the location of the article of personal property.

19. A method for informing a registrant of a current location of a forgotten recent purchase as recited in claim 18, wherein the machine readable code is provided upon at least one of:
a label adhered to the article of personal property,
a tag tied to the article of personal property,
a button mechanically secured to the article of personal property, and
a receipt printed at the time of purchase of the article of personal property, the receipt being carried by a package containing the article of personal property.

20. A method for informing a registrant of a current location of a misplaced article of personal property as recited in claim 13, wherein the step of transmitting a message to the registrant associated with the acquired package identifier, wherein the message informs the registrant of the location of the misplaced package is accomplished by a least one of:
transmitting an email,
transmitting a message using Short Message Service (SMS),
transmitting a message using Multimedia Messaging Service (MMS),
providing an audible telephone message,
providing an automated telephone message,
posting a message to an associated social media site, and
providing a push notification.
